(19) United States
(12) Patent Application Publication
(10) Pub. No.: US 2007/0277655 A1
(43) Pub. Date: Dec. 6, 2007

(54) Cutting apparatus, honeycomb molded body cutting method, and honeycomb structure manufacturing method

(76) Inventors: Tsuyoshi Kawai, Gifu (JP); Yoshiteru Ohira, Gifu (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/513,115

(22) Filed: Aug. 31, 2006

(30) Foreign Application Priority Data
Jun. 5, 2006 (EP) 06114959.7

(51) Int. Cl. B26D 1/00; B26D 3/00

(52) U.S. Cl. 83/13

(57) ABSTRACT

The cutting apparatus of the present invention is a cutting apparatus to execute cutting the end portion of a pillar-shaped honeycomb molded body having multiple cells that are established in rows in the longitudinal direction and partitioned by cell walls, and is provided with a rotary body having a rotary shaft established horizontally, a molded body clamping member configured to clamp the honeycomb molded body established on the rim of the rotary body, and at least one cutting disk, and is configured in such a manner as to execute cutting of an end portion of the honeycomb molded body while the honeycomb molded body, which is clamped by the molded body clamping member, is in a state of being put in motion according to the rotary movement of the rotary body.

### CROSS-REFERENCE TO RELATED APPLICATIONS

This application claims benefit of priority based on European Patent Application No. 06114959.7 filed on Jun. 5, 2006. The contents of this application are incorporated herein by reference in their entirety.

### BACKGROUND OF THE INVENTION

1. Field of the Invention

The present invention relates to cutting apparatuses, methods for cutting a honeycomb molded body, and methods for manufacturing a honeycomb structure.

2. Discussion of the Background

Particulates such as soot and the like contained in the exhaust gas expelled by the internal combustion engines of vehicles such as busses, trucks and the like, and construction equipment and the like, have become a problem of recent, in that they cause harm to the environment and the human body. To remedy this, there are currently being proposed numerous types of honeycomb filters using a honeycomb structure of porous ceramic as a filter for capturing particulates contained in exhaust gasses, and thus purifying the exhaust gas.

FIG. 1 is a perspective view schematically showing an example of such a honeycomb filter. FIG. 2A is a perspective view showing a honeycomb fired body that comprises the above honeycomb filter in a visually modeled manner, while FIG. 2B is a cross-sectional view thereof, taken on line A-A.

In a honeycomb filter 130, a plurality of honeycomb fired bodies 140, of the kind shown in FIG. 2, are bound together through a sealing material layer (an adhesive layer) 131 forming a ceramic block 133, and a sealing material layer (a coat layer) 132 is formed over the exterior circumference of the ceramic block 133.

And comprising the honeycomb fired body 140 are, as shown in FIG. 2, a multitude of cells 141, established in rows along the longitudinal direction, and cell walls 143, which partition the cells 141 individually, and provide filtration functionality.

Put more plainly, the end portion on either the entrance side or the exit side of the cells 141 formed in the honeycomb fired body 140 are sealed by a plug material layer 142 as shown in FIG. 2B. The exhaust gas which enters one cell 141 passes through the cell walls 143 separated by the cells 141 without fail, to flow out through another cell 141. When the exhaust gas passes through the cell wall 143 particulates contained within the exhaust gas are captured by the cell wall 143, thus purifying the exhaust gas.

Conventionally, when manufacturing this sort of honeycomb filter 130, first, ceramic powder, binder, and a liquid dispersal medium are combined to prepare a moist composite. The moist composite is then extraction molded continuously by dicing, and the extruded molded body is cut to a prescribed length. Thus produces a rectangular pillar-shaped honeycomb molded body.

Next, the honeycomb molded body attained above is dried using microwave drying or hot air drying. The dried honeycomb molded body is then cut by a cutting apparatus to a prescribed length, which achieves the final product, that is, the honeycomb filter. Afterward, plugs are administered to either end of prescribed cells using a plug material layer to achieve a sealed state of the cells. After the sealed state has been achieved, degreasing and firing treatment is administered, thus producing the honeycomb fired body.

After this, a sealing material paste is coated onto the sides of the honeycomb fired bodies, and using an adhesive the honeycomb fired bodies are adhered together. This state of a multitude of honeycomb fired bodies being bonded together with a sealing material layer (an adhesive layer) effectuates a honeycomb fired body aggregate. The achieved aggregate of honeycomb fired bodies is then administered cutting processing using an cutting machine, or the like, to achieve a ceramic block of a prescribed form, such as cylindrical or cylindroid form and the like. Finally, sealing material paste is coated over the exterior circumference of the ceramic block to form a sealing material layer (a coat layer), thus completing the manufacturing of the honeycomb filter.

As a method for cutting a honeycomb molded body, there is disclosed a solution to the above problem a cutting method for use when cutting a unit honeycomb molded body from a long honeycomb molded body (JP-A 2003-220605). Further, disclosed in JP-A 2003-220605 is a cutting method in which a long honeycomb molded body is clamped in place using a cut-site chuck at a location near the cut site, and angle adjustment is carried out in order to make sure that the cutting blade is positioned perpendicularly with respect to the exterior circumference of the long honeycomb molded body cut site.

The contents of JP-A 2003-220605 are incorporated herein by reference in their entirety.

### SUMMARY OF THE INVENTION

The cutting apparatus of the present invention is configured to cut an end portion of a pillar-shaped honeycomb molded body having a multiplicity of cells that are established in rows in the longitudinal direction and partitioned by cell walls, the cutting apparatus comprising:

a rotary body having a rotary shaft established horizontally; a molded body clamping member configured to clamp a honeycomb molded body established on the rim of the rotary body; and at least one cutting disk, wherein

the cutting apparatus is configured in such a manner as to execute cutting of an end portion of the honeycomb molded body while the honeycomb molded body, which is clamped by the molded body clamping member, is in a state of being put in motion according to the rotary movement of the rotary body.

In the cutting apparatus of the present invention, the rotary body desirably has a disc form.

In the cutting apparatus of the present invention, desirably, the molded body clamping member is provided with a pair of opposing holding members, and is configured to hold the honeycomb molded body in a manner exposing both end portions of the honeycomb molded body when clamping the honeycomb molded body.

In the cutting apparatus of the present invention, desirably, the molded body clamping member is provided with two pairs of separated opposing holding members, and is configured to hold the honeycomb molded body in a manner exposing both end portions of the honeycomb molded body when clamping the honeycomb molded body, and desirably the contact width of a single holding member of the molded body clamping member with respect to the honeycomb molded body is about 10 mm or more.

In the cutting apparatus of the present invention, the molded body clamping member is desirably configured to hold both sides of the cut site of the honeycomb molded body simultaneously when clamping the honeycomb molded body. Also, the molded body clamping member is desirably provided with two pairs of holding members configured to interpose the cut site therebetween, and is configured to hold both sides of one cut site of said honeycomb molded body simultaneously, or desirably provided with a holding member in a form starting out as a single body extending from the joint site with the rotary body and forking into two separate ends, and is configured to hold both sides of one cut site of the honeycomb molded body simultaneously.

The cutting apparatus of the present invention is desirably configured in such a manner that the minimum distance between the contact portion or the contact face shared by the honeycomb molded body clamped to the molded body clamping member and the molded body clamping member, and the cut site of the honeycomb molded body is at least about 0.5 mm and at most about 1 mm.

In the cutting apparatus of the present invention, the molded body clamping member is desirably configured to clamp the honeycomb molded body in parallel with the rotary shaft of the rotary body.

In the cutting apparatus of the present invention, the molded body clamping member is desirably provided with a parallel adjustment member, and is configured in such a manner that a contact face of the parallel adjustment member with the honeycomb molded body is disposed in parallel with the rotary shaft of the rotary body.

In the cutting apparatus of the present invention, desirably, the molded body clamping member has a step portion formed thereon, and is configured in such a manner that, when the honeycomb molded body is clamped to the step portion to fit exactly, the clamped honeycomb molded body is in parallel with the rotary shaft.

In the cutting apparatus of the present invention, desirably, the cutting apparatus is provided with two of the cutting disks, thus enabling cutting of both end portions of the honeycomb molded body simultaneously.

In the cutting apparatus of the present invention, the cutting disk is desirably in a form in which the thickness of a rim-zone portion gradually becomes smaller towards the outer rim.

In the cutting apparatus of the present invention, the cutting disk is desirably in a form in which the thickness of a center portion and that of a rim-zone portion are relatively large, while the thickness of a portion between the center portion and the rim-zone portion is small compared to that of the center portion and that of the rim-zone portion.

In the cutting apparatus of the present invention, the cutting disk is desirably in a form in which only the rim-zone portion is thick.

In the cutting apparatus of the present invention, the cutting disk desirably has a thickness of at least about 0.4 mm and at most about 2 mm, and desirably has a diameter of at least about 100 mm and at most about 300 mm.

In the cutting apparatus of the present invention, the cutting disk desirably comprises steel blades constituting steel, sintered-type diamond blades using metallic powder bond, sintered-type diamond blades using thermosetting resin, blades formed from steel core and diamond metal bonded and united as one, or blades from industrial diamond clamped with electrocast bond, and abrasive grains made of diamond powder, alumina powder, silicon carbide powder, or silicon nitride powder are desirably placed onto the cutting disk.

The honeycomb molded body cutting method of the present invention is configured to enable cutting of a pillar-shaped honeycomb molded body having a multiplicity of cells that are established in rows in the longitudinal direction and partitioned by cell walls according to using a cutting apparatus, the cutting apparatus comprising:

a rotary body having a rotary shaft established horizontally; a molded body clamping member configured to clamp a honeycomb molded body established on the rim of the rotary body; and at least one cutting disk, wherein

the honeycomb molded body cutting method is configured to perform cutting of the end portion of the honeycomb molded body according to the cutting disk, while moving the honeycomb molded body according to the rotary movement of the rotary body, after the honeycomb molded body is clamped in place by the molded body clamping member of the rotary body.

In the honeycomb molded body cutting method of the present invention, it is desirable that the cutting apparatus of the present invention is used as the above-mentioned cutting apparatus.

The honeycomb structure manufacturing method of the present invention is configured to manufacture a honeycomb structure made from a honeycomb fired body attained by molding ceramic raw material to form a pillar-shaped honeycomb molded having a multiplicity of cells established in rows in the longitudinal direction and partitioned by cell walls, and subsequently using a cutting apparatus to execute a cutting process to cut both ends of the honeycomb molded body, and firing the honeycomb molded body thereafter, the cutting apparatus comprising:

a rotary body having a rotary shaft established horizontally; a molded body clamping member configured to clamp a honeycomb molded body established on the rim of the rotary body; and at least one cutting disk, wherein

the honeycomb structure manufacturing method is configured to, according to the cutting process, perform cutting of an end portion of the honeycomb molded body according to the cutting disk, while moving the honeycomb molded body according to the rotary movement of the rotary body, after the honeycomb molded body is clamped in place by the molded body clamping member.

In the honeycomb structure manufacturing method of the present invention, it is preferable that the cutting apparatus of the present invention is used as the cutting apparatus.

In the honeycomb structure manufacturing method of the present invention, it is also preferable that a drying treatment is administered to the honeycomb molded body after the honeycomb molded body has been produced by molding ceramic raw materials, yet before both ends of the honeycomb molded body are cut.

### BRIEF DESCRIPTION OF THE DRAWINGS

FIG. 1 is a perspective view schematically showing an example of a honeycomb filter.

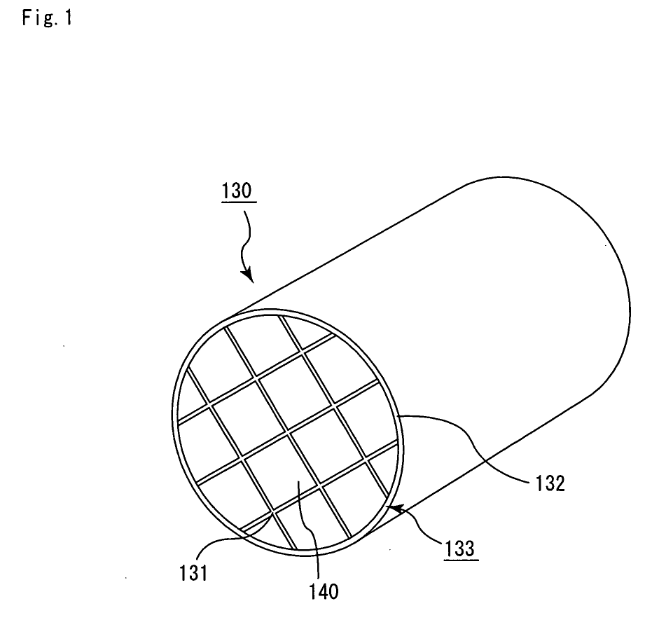

FIG. 2A is a perspective view schematically showing a honeycomb fired body comprising the above mentioned honeycomb filter, and FIG. 2B is a cross-sectional view corresponding to line A-A of FIG. 2A.

FIG. 3 is a view schematically showing an example of a cutting apparatus of the present invention.

FIGS. 4A to 4D are views schematically showing a molded body clamping member in the state of having clamped thereon a honeycomb molded body, and depicts various embodiments of the molded body clamping member as seen from the direction indicated by arrow A in FIG. 3.

FIGS. 5A and 5B are views schematically showing a method of clamping the honeycomb molded body into the molded body clamping member in parallel with the rotary shaft of a rotary body.

FIGS. 6A and 6C are plan views each schematically showing an example of a cutting disk comprising the cutting apparatus of the present invention, and FIGS. 6B and 6D are the cross-sectional views corresponding to line A-A of FIGS. 6A and 6C, respectively.

### DESCRIPTION OF THE EMBODIMENTS

First, the embodiment of the cutting apparatus of the present invention, as well as the embodiment of the honeycomb molded body cutting method of the present invention, will be described.

The cutting apparatus according to the embodiments of the present invention is configured to cut an end portion of a pillar-shaped honeycomb molded body having a multiplicity of cells that are established in rows in the longitudinal direction and partitioned by cell walls, the cutting apparatus comprising:

a rotary body having a rotary shaft established horizontally; a molded body clamping member configured to clamp a honeycomb molded body established on the rim of the rotary body; and at least one cutting disk, wherein

the cutting apparatus is configured in such a manner as to execute cutting of an end portion of the honeycomb molded body while the honeycomb molded body, which is clamped by the molded body clamping member, is in a state of being put in motion according to the rotary movement of the rotary body.

In the present specification, the shape indicated by the word “pillar” refers to any desired shape of a pillar including a round or polygonal pillar.

The honeycomb molded body cutting method according to the embodiments of the present invention is configured to enable cutting of a pillar-shaped honeycomb molded body having a multiplicity of cells that are established in rows in the longitudinal direction and partitioned by cell walls according to using a cutting apparatus, the cutting apparatus comprising:

a rotary body having a rotary shaft established horizontally; a molded body clamping member configured to clamp a honeycomb molded body established on the rim of the rotary body; and at least one cutting disk, wherein

the honeycomb molded body cutting method is configured to perform cutting of the end portion of the honeycomb molded body according to the cutting disk, while moving the honeycomb molded body according to the rotary movement of the rotary body, after the honeycomb molded body is clamped in place by the molded body clamping member of the rotary body.

Here, pillar-shaped honeycomb molded bodies put forth in background art can be suitably used as the pillar-shaped honeycomb molded body to be cut using the cutting apparatus and cutting method according to the embodiments of the present invention.

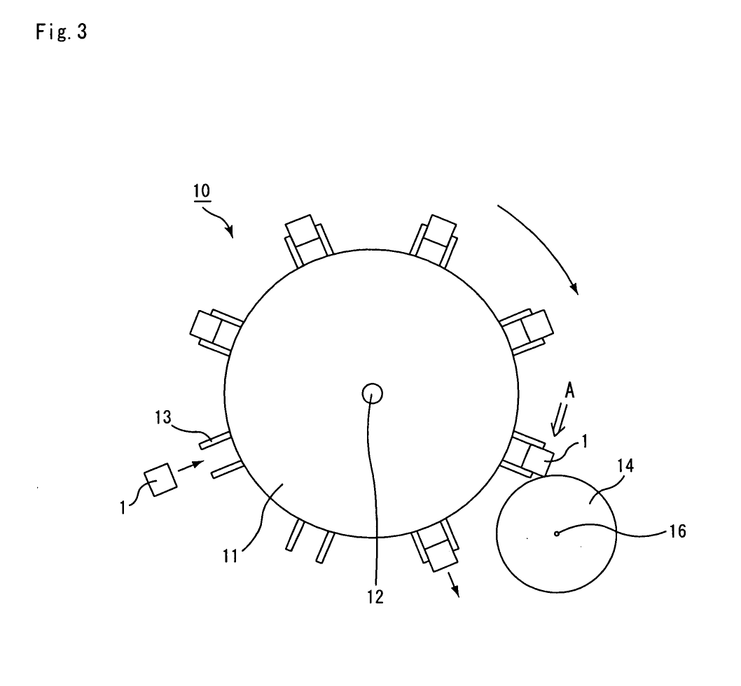

FIG. 3 is an exemplary schematic view of the cutting apparatus of the present invention.

A cutting apparatus 10 provides a rotary body 11, a molded body clamping member 13, and a cutting disk 14. Established on the rotary body 11 horizontally is a rotary shaft 12. The molded body clamping member 13, which serves to accommodate a honeycomb molded body 1, is established on the rim of the rotary body 11. The cutting disk 14 serves to execute cutting of the honeycomb molded body 1, which is clamped in place by the molded body clamping member 13. The cutting apparatus 10 rotates the rotary body 11 putting the honeycomb molded body 1 clamped in place by the molded body clamping member 13 in a state of movement following a circular path, and in this state, an end portion of the honeycomb molded body 1 is cut by the cutting disk 14. The cutting apparatus 10 is configured as is put forth hereinabove in this paragraph.

The rotary body 11, having the horizontally established rotary shaft 12, can rotate around the center of the rotary shaft 12. Also, the physical form of the rotary body 11 is not only limited to the disc form shown in FIG. 3, but can also be carried out by a polygonal form or even a star form. In a case in which a plurality of molded body clamping members 13 are established on the rotary body 11, the physical form of the rotary body 11 is not particularly limited, as long as it is a form that permits uniformity of the distance of the space in between the rotary shaft 12 and the molded body clamping members 13. The disc form in particular is of particular desirability as such a physical form.

In the case in which the physical form of the rotary body 11 is carried out in disc form, the diameter of the rotary body 11 is not particularly limited, and it is possible give thought to factors such as the number of cutting processes to be administered to the honeycomb molded body over a unit of time, or the spatial area to be occupied by the cutting apparatus, and make arbitrary rearrangements thereto accordingly. The illustrative diameter of the rotary body 11 is, for example, put forth as being at least about 300 mm and at most about 1000 mm.

The rotary body 11 is a disc of prescribed thickness, and the thickness of the rotary body 11 may be arbitrarily changed according to the length and the like of the honeycomb molded body 1 to which cutting is to be executed, for example. Because the rotary body 11 is of a prescribed thickness, it is possible to establish the molded body clamping member 13, which is for the purpose of clamping in place the honeycomb molded body 1, on the rim of the rotary body 11. Therefore, in this specification, the term “rim of the rotary body” refers to the side of the rotary body that looks like a belt strip when viewing the rotary body from the direction perpendicular to the rotary shaft. And the width of this belt is also the thickness of the rotary body.

Here, it is preferable that the rim of the rotary body 11 is parallel with the rotary shaft 12 at least at the molded body clamping member 13.

By being parallel with the rotary shaft 12, the rim of the rotary body 11 makes it easier for the honeycomb molded body 1 to be more easily horizontally clamped in place in the molded body clamping member 13, which thus makes it easier to perform cutting of the honeycomb molded body 1 with the cutting disk 14 in a direction perpendicular with respect to the longitudinal direction of the honeycomb molded body 1.

Established thereon the rim of the rotary body 11 is the molded body clamping member 13 for the purpose of clamping in place the honeycomb molded body 1.

The mechanism employed by the molded body clamping member 13 for holding the honeycomb molded body is not particularly limited to a state of actual holding of the honeycomb molded body itself, and as shown in FIG. 3, may be carried out in a form providing holding members disposed on opposite sides, with which the honeycomb molded body 1 is meant to be held in a sandwiched state, or, in a form providing a suction mechanism with which the honeycomb molded body is meant to be held under a suction force, or, in a form providing a combination of these mechanisms.

In a case in which the honeycomb molded body 1 is held by a molded body clamping member 13 comprised by opposing holding members, the holding member pair are disposed apart at a distance that is roughly the same distance as the height (or width) of the honeycomb molded body 1. Clamping is completed after the honeycomb molded body 1 is moved to a position where it lies in between the holding members, and thus is held in a sandwiched state.

Means for carrying out movement of the honeycomb molded body 1 into the molded body clamping member 13 is not particularly limited. It is acceptable to carry out movement of the honeycomb molded body 1 into the molded body clamping member 13 by way of placement by a human being, to carry out the same movement by first adjusting the position of the molded body clamping member 13 to the honeycomb molded body 1 placed on a conveyer line, and then convey the honeycomb molded body 1 to the molded body clamping member 13 slidingly, with a extrusion mechanism and the like, or to carry out the same movement by way of fully automated robotic means.

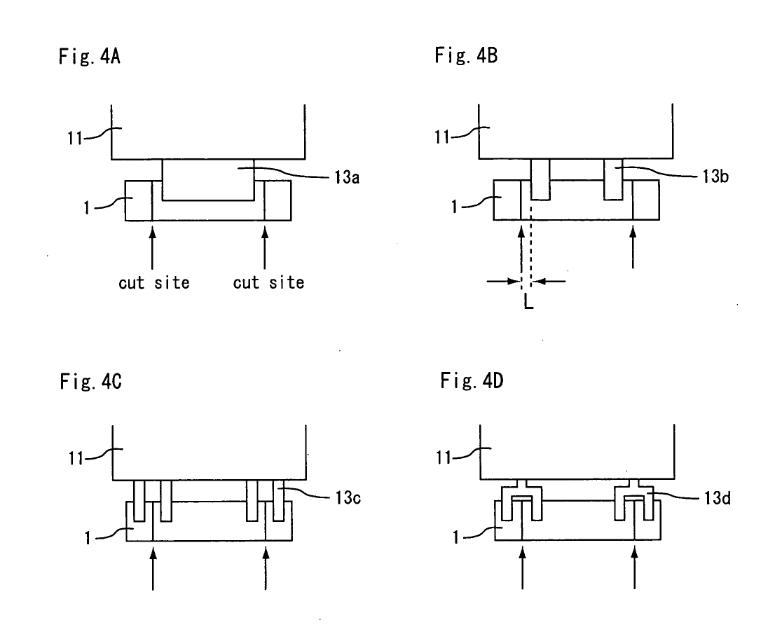

FIGS. 4A to 4D are various embodiments of the molded body clamping member viewed from the direction indicated by arrow A of FIG. 3, and schematically showing the state of the molded body clamping member having clamped in place thereon the honeycomb molded body.

As shown in FIG. 4A, a molded body clamping member 13a, comprised by a pair of opposing holding members (In the figures, only one of the holding member pair is shown) facing the rim of the rotary body 11, is disposed, and the honeycomb molded body 1 is clamped in place on the molded body clamping member 13a.

The molded body clamping member 13a holds the honeycomb molded body 1 in a manner exposing both end portions of the honeycomb molded body 1, and the same exposed end portions are cut by the disk cutting 14. FIG. 4A shows a case in which both end portions of the honeycomb molded body 1 are cut, thus giving two cut sites. This means that in this case the cutting apparatus according to one embodiment of the present invention provides two cutting disks 14. However, the embodiment is not limited to that shown in the figure, as long as at least one cutting disk 14 is provided by the cutting apparatus of the present invention. Therefore, in a case in which only one cutting disk is provided by the cutting apparatus of the present invention, only one end portion of the honeycomb molded body will be cut. And likewise hereinafter, in FIGS. 4B to 4D, it is acceptable to have only one cut site or two cut sites.

And here, the only things shown are various examples of configurations of the molded body clamping member, and herein below will be description of the cutting of the end portions of the honeycomb molded body, executed with the cutting disk.

FIG. 4B shows a molded body clamping member 13b providing two pairs of opposing holding members. The molded body clamping member 13, similar to the embodiment shown in FIG. 4A, holds the honeycomb molded body 1 in a manner exposing both end portions of the honeycomb molded body 1.

In a case in which the molded body clamping member 13 is comprised by two pairs of separated holding members, it is possible to realize a molded body clamping member 13b of miniaturized proportions in comparison to the molded body clamping member 13a, which is comprised by a single pair of holding members. By establishing a holding member of such a configuration, minute-scale adjustments of the pressing force with respect to the honeycomb molded body can be carried out, making it possible to optimize clamping of the honeycomb molded body by the molded body clamping member. On the other hand, if realized size of the molded body clamping member 13 is excessively small, there arises the risk of denting, caused by the pressing force applied by the holding member. Therefore, it is preferable that the realized contact width of a single holding member of the molded body clamping member 13 with respect to the honeycomb molded body 1 be about 10 mm or more.

With the cutting apparatus according to the embodiments of the present invention, cutting of at least one of the end portions of the honeycomb molded body 1 is carried out according to the cutting disk, while the molded body clamping member 13b serves as the point of support. Because of this, it is preferable that the distance between the molded body clamping member 13 and the cut site be in close proximity. As with the embodiment shown in FIG. 4B, as long as the molded body clamping member 13 is constituted as separated pairs, even in cases where there exist two cut sites, it may become easier to place the honeycomb molded body 1 in contact with the molded body clamping member 13 so that the cut site is located as close in proximity to the molded body clamping member 13 as possible. Thus it may become easier to effectively avoid bad cuts during cutting time.

Furthermore, it is preferable that the molded body clamping member 13 be configured in such a manner allowing both sides of a cut site of the honeycomb molded body 1 to be held simultaneously when clamping the honeycomb molded body 1 in place.

Shown in FIG. 4C is an example of a molded body clamping member configured in such a manner, thus making it possible to simultaneously hold both sides of one cut site of the honeycomb molded body 1. Put simply, two pairs of holding members are each disposed on the side of one cut site of the honeycomb molded body 1, in such a manner so as to hold both sides of the same cut site. Thus, the molded body clamping member 13c is able to hold both sides of the same cut site simultaneously. In FIG. 4C, there exist two cut sites, and the molded body clamping member 13 holds both sides of each of the cut sites. Thus, in total, there are four pairs of holding members constituting the molded body clamping member 13c.

In a case in which only one side of the cut site to be cut on the honeycomb molded body 1 is held by the molded body clamping member 13, and the opposing side of the same cut site is a free end not held by the molded body clamping member 13, there can occur deviation or slips toward the side of the free end while the cutting disk advances through a cut. In a situation in which deviation or slipping has occurred, defects, damage, or cracking can occur on the rim of the cut site before cutting is finished.

However, if the molded body clamping member 13 is configured in such a manner allowing it to hold both sides of the cut site of the honeycomb molded body 1 simultaneously, it may become easier to prevent the above problem of deviation and slipping, and therefore it may become easier to prevent the change in shape such as defects, deformation and the like, and cracking of the rim during cutting of the honeycomb molded body 1.

Furthermore, the embodiment exemplarily shown in FIG. 4D can be given as a different example of a molded body clamping member 13 configured in such a manner allowing it to hold both sides of the cut site of the honeycomb molded body 1 simultaneously.

Introduced in FIG. 4D, a molded body clamping member 13d has a configuration similar to that of the molded body clamping member 13b shown in FIG. 4B at the joint site with the rotary body 11. However, the molded body clamping member 13d is different from the molded body clamping member 13b in that the each constituent member of a single holding member pair, although starting out as a single body extending from the rotary body 11, fork out into two separate ends. Even with formation in this manner, the molded body clamping member 13d, is able to hold both sides of the cut site of the honeycomb molded body 1 simultaneously, and therefore may more easily enable the prevention of change in shape such as defects, deformation and the like, and cracking of the rim during cutting of the honeycomb molded body 1.

It is preferable that the pressing force of the holding members with respect to the honeycomb molded body 1 while it is clamped in place by the molded body clamping member 13 be at least about 10 kPa and at most about 50 kPa, though the pressing force may vary according to the particular strength or size of the honeycomb molded body 1.

At a holding member pressing force of about 10 kPa or more, it may become easier to maintain a sure hold on the honeycomb molded body 1. And at a pressing force of about 50 kPa or less, there may be less risk of dents or damage being generated on the portion of the surface of the honeycomb molded body 1 where the holding member makes contact.

And as long as the honeycomb molded body 1 is surely clamped in place, the portion (or face) of the molded body clamping member 13 that contacts the honeycomb molded body 1 may also comprise a soft material, in order to prevent damage to the surface of the honeycomb molded body 1. Materials such as urethane resin, natural rubber, styrene butadiene rubber, silicon rubber, hemp cloth, silk cloth, and the like, for example, may be used as such a soft material.

In a case in which a honeycomb molded body is clamped by the molded body clamping member, it is preferable that the minimum distance (the distance “L” shown in FIG. 4B) between the contact portion or the contact face shared by the honeycomb molded body and the molded body clamping member, and the cut site of the honeycomb molded body be at least about 0.5 mm and at most about 1 mm.

If the distance between the molded body clamping member and the cut site is about 0.5 mm or more, collision between the cutting disk and the molded body clamping member becomes less likely to occur. On the other hand, if the same distance is about 1 mm or less, the distance between the cut site, which is the point of force, and the molded body clamping member, which is the point of support, is less likely to be too great, and it may become likely that the strength of the honeycomb molded body bears the stress applied during cutting, which tends not to cause deformation or even destruction of the honeycomb molded body.

It is possible to set the number of molded body clamping members to be disposed by considering the requirements with respect to factors such as the spatial dimensions and available installation space of the rotary body, the interval distance for disposal onto the rim of the rotary body, and the number of cutting processes per unit of time. With the cutting apparatus of the present invention, in a case in which the rotary body is a disc having a diameter of about 550 mm, about 8 to about 15 molded body clamping members may be considered to be a suitable disposal number, for example.

It is preferable for the molded body clamping member 13 to be constituted in a manner permitting the clamping of the honeycomb molded body 1 in parallel with respect to the rotary shaft 12 of the rotary body 11. If the honeycomb molded body 1 is clamped in place by the molded body clamping member 13 so that it is parallel with the rotary shaft 12 of the rotary body 11, this means that it may become easier to execute cutting of the honeycomb molded body 1 in the direction perpendicular to the longitudinal direction of the honeycomb molded body 1, according to the cutting disk 14 (put forth herein below), which has a cutting face that is perpendicular to the rotary shaft 12.

The method of clamping the honeycomb molded body 1 in place horizontally with respect to the rotary shaft 12 of the rotary body 11 is not particularly limited. It is possible to freely use any method, as long as the purpose of the method, put forth in the sentence above, is fulfilled. Such methods may be: a method wherein the honeycomb molded body is grasped using a grasping mechanism able to grasp the honeycomb molded body in parallel the rotary shaft 12 before clamping it in place with the molded body clamping member, a method wherein adjustment to the degree of horizontally is carried out with an adjustment mechanism after clamping, a method in which there is provided, thereon the molded body clamping member, a pre-prepared parallel adjustment member for the purpose of adjusting for horizontally with respect to the rotary shaft, and executing clamping of the honeycomb molded body while pressing it against the adjustment member, or other methods.

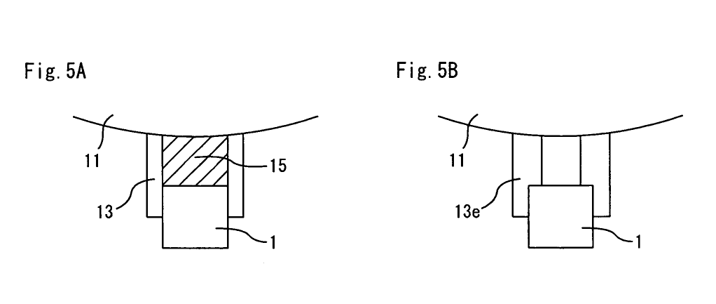

FIG. 5A and FIG. 5B are schematic diagrams showing examples of the method of using the molded body clamping member to clamp the honeycomb molded body in parallel the rotary shaft of the rotary body.

In FIG. 5A, shown are the rotary body 11, the molded body clamping member 13 established on the rim of the rotary body 11, a parallel adjustment member 15 pre-provided on the molded body clamping member 13, and the honeycomb molded body 1, which is pushed against the parallel adjustment member 15 and clamped by the molded body clamping member 13.

Regarding the parallel adjustment member 15, the contact face of the parallel adjustment member 15 with the honeycomb molded body 1 is disposed in a manner making it parallel with the rotary shaft 12 of the rotary body 11. Therefore, if the honeycomb molded body 1 is pushed against the parallel adjustment member 15 and clamped by the molded body clamping member 13, it may become easier to achieve a state in which the honeycomb molded body 1 is clamped in parallel with the rotary shaft 12. In this manner, if the parallel adjustment member 15 is pre-provided on the molded body clamping member 13, it may become easier to clamp the honeycomb molded body 1 with the molded body clamping member 13 in parallel with the rotary shaft 12, without need of complicated methods, devices or the like.

It is acceptable that the parallel adjustment member 15 be disposed partially, or entirely, in the thickness direction on the rim of the rotary body 11. It is desirable that in a case in which the parallel adjustment member 15 is disposed partially in the thickness direction, that one or both end portions of the honeycomb molded body 1 be located outside of the end portions of the parallel adjustment member 15, when the honeycomb molded body 1 is being clamped by the molded body clamping member 13. And in cases in which the parallel adjustment member 15 is disposed entirely in thickness direction, it is desirable that a notch be formed at the location corresponding to the cut site of the honeycomb molded body. By carrying out the parallel adjustment member 15 in these desirable modes, it may become easier to execute smooth cutting of the honeycomb molded body 1 according to the cutting disk 14.

FIG. 5B is a plan view schematically showing another example of a honeycomb molded body being clamped by the molded body clamping member in parallel with the rotary shaft of the rotary body.

FIG. 5B shows the rotary body 11, and a state of having a molded body clamping member 13e established on the rim of the rotary body 11, and the honeycomb molded body 1 being clamped by the molded body clamping member 13e. Formed thereon the molded body clamping member 13e, is a step portion, which is able to hold the honeycomb molded body 1 in place horizontally with respect to the rotary shaft 12. When the honeycomb molded body 1 is clamped in place by the molded body clamping member 13e, if the honeycomb molded body 1 mentioned above is clamped in such a manner that it fits perfectly, the clamped honeycomb molded body 1 is in a state of horizontally with respect to the rotary shaft 12. Even in such a case, it may become easier to achieve clamping of the honeycomb molded body 1 in parallel with the rotary shaft 12 according to the molded body clamping member 13e even without use of complicated means, mechanisms or the like.

The method, mechanisms and the like used to clamp the honeycomb molded body 1 in parallel with the rotary shaft 12 of the rotary body 11 according to the molded body clamping member 13 is not limited to the above-mentioned methods, and methods, mechanisms and the like also able to achieve the same effects also fall under the scope of the present invention.

Although description has been put forth with regard to the molded body clamping member comprising the cutting apparatus according to the embodiments of the present invention with reference to FIGS. 4 and 5, it may become easier to achieve a state of secure holding of the honeycomb molded body even in cases using any one of the embodiments. In particular, if the molded body clamping member is configured in such a manner allowing it to hold both sides of the cut site of the honeycomb molded body simultaneously, it may become easier to prevent physical defects, damage, and deformation and the like from being generated on the cut site of the honeycomb molded body, and thus, it may become easier to attain a honeycomb molded body of suitable appearance and form.

Also, it may become easier to clamp a honeycomb molded body in parallel with the rotary shaft of the rotary body according to the molded body clamping member by forming a step portion on the molded body clamping member, and disposing a parallel adjustment member on the same molded body clamping member. Therefore, it may become easier to execute cutting of the end portions of a honeycomb molded body in such a manner that will constantly assure that the cut face of the honeycomb molded body is perpendicular to the longitudinal direction.

The cutting apparatus according to the embodiments of the present invention provides at least one cutting disk.

FIG. 3 shows a cutting disk 14 for the purpose of executing cutting of the honeycomb molded body 1. The same cutting disk 14 has a disc form of low thickness. The cutting disk 14, in the same manner as the rotary body 11, has a center shaft 16 established horizontally. The center shaft 16 at its center, the cutting disk 14 rotates at high speed. In the cutting apparatus of the present invention, the configuration of the cutting disk 14 is not particularly limited. However, it is preferable that the cutting disk 14 be configured having the center shaft 16 established horizontally, a rotary face perpendicular to the center shaft 16, and that the cutting disk 14 use the center shaft 16 as a center of rotation.

With configuration in this manner, it may become easier for the cutting disk 14 to perpendicularly cut into the honeycomb molded body 1 clamped in place horizontally with respect to the rotary shaft 12 of the rotary body 11, and therefore, it may become easier to cut the end face of the honeycomb molded body 1 perpendicular to the longitudinal direction.

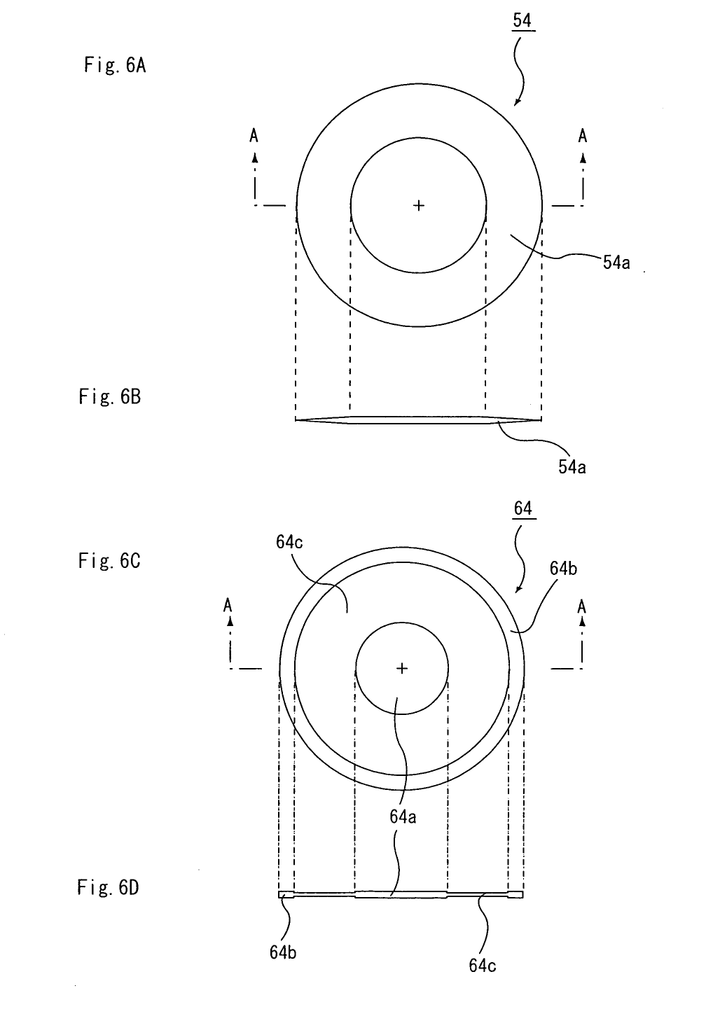

The physical form of the cutting disk 14 is not particularly limited, a form as seen in FIG. 6 is given as a concrete example. FIGS. 6A and 6C are plan views that each schematically showing an example of a cutting disk comprising the cutting apparatus of the present invention. FIGS. 6B and 6D are cross-sectional views taken on line A-A of FIGS. 6A and 6C, respectively.

Put plainly, the form of the above mentioned cutting disk, in the manner of a cutting disk 54 shown in FIGS. 6A and 6B, is acceptable in a form having the thickness of a rim-zone portion 54a of the cutting disk gradually lessen as one proceeds in a direction toward the outer rim. In another acceptable form for the above mentioned cutting disk, in the manner of a cutting disk 64 shown in FIGS. 6C and 6D, the thicknesses of a center portion 64a and that of a rim-zone portion 64b are relatively large, while the thickness of a portion (a mid portion) 64c between the center portion 64a and that of the rim-zone portion 64b is small compared to that of the center portion 64a and that of the rim-zone portion 64b. In yet another acceptable form for the above mentioned cutting disk, although not shown in the figures, another acceptable form is a disk shape with the thickness of the entire cutting disk being uniform, or, in yet another acceptable variation, only the rim-zone portion of the cutting disk is thick.

Out of all of the acceptable form variations put forth above, the form variation in which at least the thickness of the rim-zone portion is thick, is most preferable.

In a case having such a form, because the only portion of the cutting disk that contacts the honeycomb molded body during cutting is the rim-zone portion, it may be possible to use, for example, a material having a high degree of hardness, such as diamond and the like, as its material. Thus it may be possible to alternately use materials having a lower degree of hardness than that of the rim-zone portion, such as steel and the like for example, as the material for other regions. Thus, in such a case, it may become easier to cut the cost of the cutting disk.

It is preferable that the thickness of the cutting disk 14 lies at least about 0.4 mm and at most about 2 mm.

With a thickness of about 0.4 mm or more, the rate of wear and tear on the cutting disk 14 tends not to be great, which would make it less necessary to replace the cutting disk on a frequent basis. On the other hand, with a thickness of about 2 mm or less, the cutting disk 14 may not tend to apply to great a shearing stress to the cut site of the honeycomb molded body 1, resulting in a lower risk of bad cuts stemming from defects of the rim, deformation and the like.

It is possible to change the diameter of the cutting disk 14 according to factors such as number and speed of revolutions of the cutting disk 14, and the physical dimensions of the honeycomb molded body. As an example, a cutting disk diameter of at least about 100 mm and at most about 300 mm would be acceptable.

If the diameter of the cutting disk 14 lies within the above mentioned range, it may become easier to raise the efficiency of the cutting process carried out to the end portions of the honeycomb molded body while conserving space, as there is no need to excessively increase the number of revolutions.

Regarding materials usable as raw material of the cutting disk 14, the following are acceptable, as long as the material considered for use is a material having resistance to wear and tear according to abrasion with ceramic material. Some such acceptable raw materials are: steel blades constituted by steel, sintered-type diamond blades using metallic powder bond, sintered-type diamond blades using thermosetting resin, blades formed from steel core (metallic support plate) and diamond metal bonded and united as one, and blades from industrial diamond clamped with electrocast bond, and the like. It is possible to use abrasive grains of diamond with a grain diameter of #320 to #1200, for example.

Furthermore, it is possible to dispose abrasive grains of diamond powder, alumina powder, silicon carbide powder, or silicon nitride powder, or the like, onto the cutting disk 14. By doing so, it may become easier to raise the cutting speed at which the cutting disk 14 performs cutting of the honeycomb molded body 1, while wear and tear of the cutting disk 14 may be more easily delayed.

The cutting apparatus according to the embodiments of the present invention, is constituted in a manner configured to perform cutting of the end portions of the above mentioned honeycomb molded body with the above mentioned cutting disk, while moving the same honeycomb molded body, which is in a state clamped in place by the above mentioned molded body clamping member, according to the rotary movement of the above mentioned rotary body.

Referring to FIG. 3, the flow of a sequence used in the cutting of the honeycomb molded body will be described. Also, detailed descriptions of the configurations, operations and the like of the rotary body 11, the molded body clamping member 13, and the cutting disk 14 have already been put forth hereinabove, and thus will be omitted in the following.

First, the honeycomb molded body 1 is clamped in place by the molded body clamping member 13. The rotary body 11 may or may not be in rotation while the honeycomb molded body 1 is clamped by the molded body clamping member 13. Concerning the rotation of the rotary body 11 during clamping of the honeycomb molded body 1 by the molded body clamping member 13, a procedure wherein the rotation of the rotary body 11 is temporarily stopped during clamping of the honeycomb molded body 1, and the rotation of the same rotary body 11 is resumed again with the completion of clamping, may be suitably employed repeatedly for continuous operation.

Next, the honeycomb molded body 1 clamped in place by the molded body clamping member 13 is moved according to the rotary movement of the rotary body 11 in the direction of the arrow. Although in the embodiment of the cutting apparatus of the present invention shown in FIG. 3 the rotary body 11 is shown in a manner wherein it rotates clockwise in the diagrams, the rotary direction is not limited to the clockwise direction, as it is also acceptable for rotation to occur in the counterclockwise direction. In this manner, the rotary body 11 rotates, and as a result of its rotation, the relative distance between the honeycomb molded body 1, clamped by the molded body clamping member 13, and the cutting disk 14 decreases.

The cutting apparatus according to the embodiments of the present invention moves a plurality of the honeycomb molded body spatially and continuously with the rotary movement of the rotary body, as mentioned above. Because of this, it may be come easier to increase the number of honeycomb molded bodies per unit of cutting apparatus installation space, thus it may become easier to permit improvements in both space conservation as well as the efficiency of operation.

Next, the honeycomb molded body 1 is moved, according to the rotary movement of the rotary body 11, to a location at which the honeycomb molded body 1 contacts the cutting disk 14, after which, by way of further movement of the honeycomb molded body 1, the end portion of the honeycomb molded body 1 is cut.

Regarding the area at which the cutting disk 14 will contact with and cut into the honeycomb molded body 1, as shown in FIG. 3, it is acceptable for the cutting disk 14 to execute cutting into the honeycomb molded body 1 from one of the corner portions formed by adjoining side faces of the honeycomb molded body 1, and is also acceptable to execute cutting into the honeycomb molded body 1 from a side face of the honeycomb molded body 1. In consideration of the need to diffuse the shear stress and the like applied to the cut site, it is most preferable to execute cutting into the honeycomb molded body 1 by the cutting disk 14 from the above corner portion of the honeycomb molded body 1.

Although, it is acceptable for the rotational direction of the cutting disk 14 to be either the same as the rotational direction of the rotary body 11 or different from the same, it is most preferable for the rotational direction of the same cutting disk 14 to be the same direction as the rotary body 11. The reason for this lies in that by providing a cutting disk 14 rotating in the same direction as the rotary body 11, it may become easier to lessen cutting speed losses by a more efficient transfer of stress applied by the cutting disk 14 toward the honeycomb molded body 1.

Also, because the path of movement that the honeycomb molded body 1 follows as it is moved according to the rotary movement of the rotary body 11 is circular, the direction (or “vector”) at which stress is applied from the cutting disk 14 to the honeycomb molded body changes with time. As a result, any stress applied becomes less likely to have the chance to focus on a specific point on the cut site of the honeycomb molded body, thus it may become easier to effectively suppress occurrences of defects of the rim, deformation and the like, on the cut site.

When the cutting of the end portion of the honeycomb molded body 1 is finished, pressing force applied to the honeycomb molded body 1 from the molded body clamping member 13 is released, and the honeycomb molded body 1, having had its end portion cut off, is removed from the cutting apparatus according to one embodiment of the present invention.

Here, it is most preferable that the cutting apparatus according to the embodiment of the present invention be configured in a manner providing two cutting disks, and being able to execute cutting of both end portions of the above mentioned honeycomb molded body simultaneously.

And as long as the cutting disk contacts both end portions of the honeycomb molded body simultaneously, it is acceptable for the cutting apparatus according to one embodiment of the present invention having the configuration mentioned above to use two cutting disks of identical form, or two cutting disks of differing diameters. In particular, it is most preferable to configure the cutting apparatus according to the embodiments of the present invention in such a manner as to permit cutting of both end portions of the honeycomb molded body according to two cutting disks of identical form, provided with the center shaft 16 thereof being positioned in the same direction.

Shown in FIG. 4 is the cut site of the honeycomb molded body 1 in a case in which the cutting apparatus of the present invention provides two cutting disks 14. If the two cutting disks 14 are established on the cutting apparatus of the present invention in a manner located at both end portions of the honeycomb molded body 1, it may become easier to execute cutting of both end portions of the honeycomb molded body, at the cut site shown in FIG. 4, simultaneously and perpendicular with respect to the longitudinal direction.

According to the cutting apparatus of the present invention configured in such a manner as to enable cutting of both end portions of the honeycomb molded body simultaneously, the honeycomb molded body is cut at the distance interval that the two cutting disks 14 are separated. Therefore, even if the clamped position of the honeycomb molded body with respect to the molded body clamping member deviates slightly in the horizontal direction, it may become easier to execute cutting of the honeycomb molded body at a constant length. Also, compared to cases in which cutting of the end portions of the honeycomb molded body is executed at separate times, executing cutting of both end portions simultaneously not only enables cutting of the honeycomb molded body at a constant length, but also makes it easier to shorten the amount of time required to cut both end portions of the same, thus the efficiency of cutting operation may be more easily improved.

In order to adjust the post-cutting length (termed “cut length” herein after) of the honeycomb molded body, when cutting the end portion of the same honeycomb molded body by sending it through a cutting line of linear flow, it is necessary to perform strict setting and adjusting of the time and positioning necessary in between the cutting of one end portion and the cutting of the other end portion. However, with the cutting apparatus of the present invention, which is configured in such a manner as to provide two cutting disks and enable cutting of both end portions of the honeycomb molded body simultaneously, it is possible to perform changes and adjustments concerning the cut length of the honeycomb molded body 1 easily, simply by changing the separation distance in between the two cutting disks 14 which results in change of the distance in between the cut sites.

With the cutting apparatus according to the embodiments of the present invention, because cutting of the honeycomb molded body is carried out while the honeycomb molded body is in a state of being moved by the rotary movement of the rotary body, while the honeycomb molded body is clamped in place by a plurality of molded body clamping members disposed on the rim of the rotary body, it is possible to carry out continuous cutting to a plurality honeycomb molded bodies. Also, because the trajectory path (so-called “path of movement”) followed when the honeycomb molded body is moved during cutting processing is circular, using rotary movement, and not linear, it is not necessary to increase the size of the cutting apparatus or the spatial area it occupies such as in cases cutting a honeycomb molded body placed on a cutting line that cuts along a linear path. It may also become easier to improve on the conservation of the spatial area that the cutting apparatus is to occupy in that it is not necessary to provide a plurality of cutting apparatuses arranged in a row in order to achieve better performance in the cutting process. In this manner, by enabling the continuous cutting of honeycomb molded bodies and conserving spatial area to be occupied by the cutting apparatus, it may become easier to improve the overall efficiency.

Because the path of movement of the honeycomb molded body is circular, the direction (or vector) in which stress is applied to the honeycomb molded body by the cutting disk changes with time. Therefore, because the shearing stress applied to the cut site of the honeycomb molded body tends not to focus on a specific area of the cut site, it may become easier to effectively prevent change in shape, such as deformation, physical defects and the like, and cracks from being generated on the cut site of the honeycomb molded body.

In addition, because cutting of the honeycomb molded body is carried out with the cutting disk having a rotary face perpendicular to the rotary shaft of the rotary body, and with the honeycomb molded body being placed on the molded body clamping member parallel to the same rotary shaft, it is possible to cut into the honeycomb molded body with the cutting disk being aligned perpendicularly with respect to the honeycomb molded body without using complicated alignment devices and mechanisms to ensure the perpendicularity of the longitudinal direction of the honeycomb molded body to the cut face of the same. Because of this, it may become easier to efficiently and easily manufacture a honeycomb molded body having a cut face (namely, an “end face”) that is perpendicular with respect to the longitudinal direction.

Also, in a case in which the molded body clamping member is configured in such a manner allowing it to simultaneously hold both sides of the cut site of the honeycomb molded body, it may become easier to prevent occurrences of deviation and slipping while the honeycomb molded body is being cut, which may occur in cases in which only one side of the cut site is held, and it may also become easier to prevent change in shape, such as deformation, physical defects and the like, and cracks from being generated on the rim of the honeycomb molded body.

Furthermore, if the cutting apparatus according to the embodiments of the present invention is configured in such a manner providing two cutting disks and thus allowing simultaneous cutting of both end portions of the honeycomb molded body, the honeycomb molded body will be cut at the length of the distance of that separates two cutting disks. Therefore, even if the clamping location of the honeycomb molded body onto the molded body clamping member is slightly deviated, it may become easier to cut the honeycomb molded body to a consistent length every time. Also, by carrying out cutting of both end portions of the honeycomb molded body simultaneously, it may become easier to shorten the overall time required for end portion cutting, and thus improve on operation efficiency.

Next, description will be put forth concerning the honeycomb molded body cutting method according to the embodiments of the present invention.

The honeycomb molded body cutting method according to the embodiments of the present invention is carried out suitably using the cutting apparatus of the present invention. Therefore, in the honeycomb molded body cutting method according to the embodiments of the present invention it is possible to execute cutting of honeycomb molded body exhibiting the functionality and effects attainable according to use of the cutting apparatus according to the embodiments of the present invention.

Because description of the embodiments of the cutting apparatus of the present invention has already been put forth herein above, the methods, conditions and the like for operation of the cutting apparatus according to the embodiments of the present invention will be mainly focused on in the description herein below.

From the initialization of cutting into the honeycomb molded body by the cutting disk, until the same cutting is completed, a rotational speed of at least about 0.5 m/min and at most about 5.0 m/min is preferable on the rim of the above mentioned rotary body.

Because the honeycomb molded body, clamped in place by the molded body clamping member, is moved according to the rotation of the rotary body, the same rotational speed correlates to the speed at which the honeycomb molded body is cut. If the above mentioned rotational speed is about 0.5 m/min or more, rim defects, deformations or the like during cutting are less likely to occur, and the processing speed of cutting is less likely to become low, making it easier to improve on efficiency of overall cutting processing. On the other hand, if the above mentioned rotational speed is about 5.0 m/minor less, the sudden shear stress tends not to be applied to the cut side, and thus rim defects or deformations may become less likely to occur.

Also, the number of rotations [min⁻¹] of the above mentioned rotary body can be derived from the relationship between the above mentioned rotational speed, and the length of the circumference of the rotary body. However, it is most preferable that the number of rotations be at least about 0.5 min⁻¹ and at most about 1.5 min⁻¹.

On the other hand, the rotational speed of the rim of the above mentioned rotary body is not particularly limited, and it is acceptable for the same rotational speed to be the same speed at the time of cutting the honeycomb molded body, or it may be different. It is possible, considering factors such as cutting processing efficiency, to apply changes as needed to the rotational speed in effect at the time at which the honeycomb molded body is in movement.

It is preferable that the peripheral velocity of the above mentioned cutting disk at the time of cutting the honeycomb molded body be at least about 2000 m/min and at most about 5000 m/min.

If the peripheral velocity of the above mentioned cutting disk is about 2000 m/min or more, the abrasive resistance between the cutting disk and the honeycomb molded body is less likely to be great, and as a result, it may become easier to attain a clean cut face, and rim defects and the like are less likely to occur. On the other hand, in cases where the peripheral velocity of the same cutting disk is about 5000 m/min or less, rim defects may become less likely to occur and the use durability characteristics of the cutting disk may not likely to be surpassed, and it may become less necessary to frequently replace the cutting disk

Also, in cases in which two cutting disks are provided on the cutting apparatus, it is most preferable that the peripheral velocity of both disks be identical, even if each disk differs in its individual size. This is to prevent occurrences of variations in the cut state of each cut site.

It is also preferable that the number of rotations of the cutting disk be at least about 550 min⁻¹ and at most about 7000 min⁻¹, in light of the relationship between the above mentioned peripheral velocity and the diameter of the cutting disk.

Also, it is acceptable, to perform cutting while providing an air blowing apparatus thereon facing the cut site, configured to blow away powder generated during cutting of the end portions of the honeycomb molded body.

With the honeycomb molded body cutting method according to the embodiments of the present invention, by using a cutting apparatus according to the embodiments of the present invention, it may become easier to achieve the continuous cutting of a honeycomb molded body, increased conservation of the operational spatial area, as well as honeycomb molded body cutting of superior efficiency. The effects achievable by the present invention, i.e., the prevention of defects, the shortening of cutting time, and the ability to cut a honeycomb molded body to a consistent length, may be more easily achievable by the honeycomb molded body cutting method according to the embodiments of the present invention if the configuration of the cutting apparatus is rearranged as needed.

Next, the honeycomb structure manufacturing method according to the embodiments of the present invention, will be described.

The honeycomb structure manufacturing method of the present invention is configured to manufacture a honeycomb structure made from a honeycomb fired body attained by molding ceramic raw material to form a pillar-shaped honeycomb molded having a multiplicity of cells established in rows in the longitudinal direction and partitioned by cell walls, and subsequently using a cutting apparatus to execute a cutting process to cut both ends of the honeycomb molded body, and firing the honeycomb molded body thereafter, the cutting apparatus comprising:

a rotary body having a rotary shaft established horizontally; a molded body clamping member configured to clamp a honeycomb molded body established on the rim of the rotary body; and at least one cutting disk, wherein

the honeycomb structure manufacturing method is configured to, according to the cutting process, perform cutting of an end portion of the honeycomb molded body according to the cutting disk, while moving the honeycomb molded body according to the rotary movement of the rotary body, after the honeycomb molded body is clamped in place by the molded body clamping member.

With the honeycomb structure manufacturing method according to the embodiments of the present invention, because the honeycomb molded body is cut according to the honeycomb molded body cutting method according to the embodiments of the present invention, it is possible to manufacture a honeycomb structure while maintaining the effects attained by the cutting apparatus according to the embodiments of the present invention. In particular, in a case in which both end portions of the honeycomb molded body are simultaneously cut by the cutting apparatus, which provides two cutting disks, the cut face is perpendicular with respect to the longitudinal direction, and it may become easier to produce honeycomb molded bodies having consistent lengths, so it may become easier to execute smooth hole-plugging processing with respect to the cells of the honeycomb molded body when aligning a plugging mask to the cut face. Also, because the lengths of the honeycomb fired bodies attained by the subsequent firing process, it may become possible to manufacture a honeycomb structure with perfectly suitable end faces.

Herein below, one embodiment of the honeycomb structure manufacturing method of the present invention will be described in the order of the process.

Here, a honeycomb structure manufacturing method in a case wherein silicon carbide powder which is a ceramic raw material is used as inorganic powder, as an example of a case in which a honeycomb molded body composed chiefly of silicon carbide is manufactured.

It is a matter of course, however, that the chief component of the honeycomb molded body is not limited to silicon carbide. Nitride ceramics such as aluminum nitride, silicon nitride, boron nitride, titanium nitride and the like, carbide ceramics such as zirconium carbide, titanium carbide, tantalum carbide and the like, and oxide ceramics such as tungsten carbide, alumina, zirconia, cordierite, mullite, aluminum titanate and the like, are suitable for use.

Of the above raw materials put forth as raw materials, antioxidant ceramics are most desirable for use, silicon carbide, in particular, is very desirable. This is because of silicon carbide in particular excels in thermal resistance, mechanical strength, and thermal conductivity. Further, ceramic raw materials such as silicon containing ceramics of metallic silicon and ceramic components, and ceramics of bound silicon or silicate compounds, are also suitable for use with the ceramic raw materials mentioned herein above, and out of them, a ceramic of silicon carbide blended with metallic silicon (silicon containing silicon carbide) is most preferable.

First, organic binder is dry mixed with an inorganic powder such as silicon carbide powder and the like having a varying mean particle diameter as the ceramic raw material. While the powder blend is being prepared, a solution blend is prepared of blended liquid plasticizer, lubricating agent, and water. Next, the above mentioned powder blend and the above mentioned solution blend are further blended together using a wet mixing machine, and thus a wet mixture for use in manufacturing the molded body is prepared.

Now although the particle diameter of the above mentioned silicon carbide powder is not particularly limited, a particle diameter having little shrinkage during the firing process is preferable. For example, a powder mix of a powder having 100 parts by weight particulate with a mean particle diameter of at least about 0.3 um and at most about 50 um, and another powder having at least about 5 parts by weight particulate and at most about 65 parts by weight particulate with a mean particle diameter of at least about 0.1 um and at most about 1.0 um, is desirable. Although in order to adjust the pore diameter of the honeycomb fired body, it is necessary to adjust the temperature at which firing takes place, the pore diameter can also be adjusted by adjusting the particle size of the inorganic powder.

The above mentioned organic binder is not limited in particular, and binders such as methylcellulose, carboxymethyl cellulose, hydroxyethyl cellulose, polyethylene glycol, phenol resin, epoxy resin and the like, for example, are acceptable for use therein. Of the binders mentioned above, methylcellulose is the most preferable.

It is preferable that the above mentioned binder be blended with the inorganic powder at a ratio of at least about 1 part by weight of binder and at most about 10 parts by weight of binder per 100 parts by weight of inorganic powder.

The above mentioned plasticizer is not limited in particular, and substances such as glycerin, for example, are acceptable for use as such.

The above mentioned lubricating agent is not limited in particular, and substances such as polyoxyalkylene compounds such as polyoxyethelyne alkyl ether, and polyoxypropylene alkyl ether, for example, are acceptable for use as such.

Some concrete examples of lubricating agents are substances like polyoxyethelyn monobutyl ether, and polyoxypropylene monobutyl ether.

Also, in some cases, it is unnecessary to use plasticizer or lubricating agent in the powdered material blend.

Also, when preparing the above mentioned wet mixture, it is acceptable to use a diffusion medium such as water, organic solvents such as benzol and the like, and alcohol and the like such as methanol and the like, for example. Further, it is also acceptable to add a mold aiding agent to the above mentioned wet mixture.

The mold aiding agent is not limited in particular, and substances such as ethylene glycol, dextrin, fatty acids, fatty acid soap, or poly alcohol, for example, may be used.

Further, it is acceptable, according to need, to add a pore-forming agent such as balloon, which is a micro sized hollow sphere, spherical acrylic particulate, or graphite, having oxidant family ceramic as a component therein, to the above mentioned wet mixture.

The above mentioned balloon is not particularly limited, as alumina balloons, glass micro balloons, shirasu balloons, fly ash balloons (FA balloons), mullite balloons and the like, for example, are all acceptable for use. Of the above mentioned, alumina balloon is the most preferable for use.

Also, it is preferable for the temperature of the above prepared wet mixture, which uses silicon carbide, to be about 28 Degrees Celsius or less. This is because if the temperature is too high, organic binder will undergo gelatinization.

It is also preferable for the inorganic ratio of within the above mentioned wet mixture to be about 10% by weight or less, and it is also preferable for the moisture content weight of the same wet mixture to be at least about 8.0% by weight and at most about 20.0% by weight.

After preparation, the above mentioned wet mixture is conveyed by a conveyer apparatus, and inserted into a molding machine.

After the wet mixture, which has been conveyed by the above mentioned conveyer apparatus, has been inserted into an extrusion molding machine, the result is molded into a prescribed form according to extrusion molding, thus forming the honeycomb molded body.

Next, using drying apparatuses such as a microwave drying machine, a hot air drying machine, a dielectric drying machine, a reduced pressure drying machine, a vacuum drying machine, or a freeze drying machine, the above mentioned honeycomb molded body is dried out, thus forming a dry honeycomb molded body.

Here, a cutting process is executed by the cutting apparatus to both ends of the honeycomb molded body produced above, thus cutting the honeycomb molded body to a prescribed length.

In the honeycomb structure manufacturing method according to the embodiments of the present invention, the rotary body having the rotary shaft established horizontally, the molded body clamping member, and the cutting apparatus, is used in order to execute cutting of the honeycomb molded body. The molded body clamping member is established on the rim of the above mentioned rotary body, and functions to clamp the honeycomb molded body in place. The cutting apparatus provides at least one cutting disk. It is possible and suitable to use the cutting apparatus according to the embodiments of the present invention, having already been put forth in detail herein above, as the cutting apparatus used in the present process.

With the cutting process of the honeycomb molded body mentioned in the present manufacturing method, for cutting the honeycomb molded body, after the above mentioned honeycomb molded body has been clamped in place according to the molded body clamping member of the above mentioned rotary body, the end portions of the above mentioned honeycomb molded body are cut off according to the above mentioned cutting disk, while the above mentioned honeycomb molded body is in a state of being moved according to the rotation of the above mentioned rotary body. It is possible and suitable to use the honeycomb molded body cutting method according to the embodiments of the present invention as the method of cutting the honeycomb molded body in the present process.

Furthermore, in the honeycomb structure manufacturing method according to the embodiments of the present invention, it is preferable that the above mentioned molded body clamping member be configured in such a manner allowing both sides of a cut site of the honeycomb molded body to be held simultaneously when clamping the honeycomb molded body in place. It is also preferable that the cutting apparatus provide two of the above mentioned cutting disks, and be able to conduct cutting of both end portions of the above mentioned honeycomb molded body simultaneously.

The reason behind this is that, as was mentioned in the description of the cutting apparatus and the honeycomb molded body cutting method according to the embodiments of the present invention, by the cutting apparatus having a configuration as above, it becomes possible to prevent rim defects and the like from occurring on the cut site of the honeycomb molded body, and it is also possible to perform cuts to a constant length, and furthermore, it becomes possible to execute cutting of both end portions of the honeycomb molded body simultaneously, which makes it easier to improve the efficiency of cutting processing.

In the above mentioned cutting process, the honeycomb molded body, to which cutting is to be carried out, may be a honeycomb molded body that has undergone extrusion molding, or a honeycomb molded body that has been administered to a drying treatment. Because it is possible to execute continuous cutting to dried or yet to be dried honeycomb molded bodies, it becomes easier to improve the efficiency of cutting processing, and, it becomes easier to attain a honeycomb molded body having end faces that are perpendicular to the longitudinal direction.

With the honeycomb structure manufacturing method according to the embodiments of the present invention in particular, it is preferable to administer the drying treatment to the above mentioned honeycomb molded body after the honeycomb molded body has been produced by molding ceramic raw materials, yet before both ends of the honeycomb molded body have been cut.

Upon administering the drying treatment to the honeycomb molded body after its ends have been cut off, the moisture content of the honeycomb molded body falls as the drying treatment progresses. There are cases in which, due to shrinkage of the honeycomb molded body due to changes in the moisture content thereof, the cut length of the honeycomb molded body immediately after the cutting of its ends differs from the cut length of the honeycomb molded body after it has been dried. However, variations in the length of the honeycomb molded body as mentioned above may be able to be prevented more easily by administering the drying treatment to the honeycomb molded body before the cutting process is administered to both ends of the same honeycomb molded body, as shrinkage will be less likely to occur.

The honeycomb molded body to which drying has been administered, due to its lower moisture content, is relatively weaker in comparison to before drying had taken place. However, because the honeycomb molded body contains organic binder, the honeycomb molded body is able to maintain strength, and thus it is possible and suitable to use the honeycomb molded body cutting method of the present invention on the above mentioned honeycomb molded body. On the other hand, because the honeycomb molded body has a high moisture content before the drying treatment is administered thereto, the honeycomb molded body is soft, and there is a risk that the form of the cells and the like will deform according to friction applied by the cutting disk. Therefore, with the honeycomb structure manufacturing method of the present invention, it is preferable to administer the drying treatment to the above mentioned honeycomb molded body before both ends of the same honeycomb molded body are cut.

Also, it is preferable that the moisture content of the honeycomb molded body, which has been administered to the drying treatment, be at least about 0 percent by weight and at most about 2 percent by weight. By the moisture content of the same honeycomb molded body being in the above mentioned range, the same honeycomb molded body maintains a suitable strength, which may make it easier to prevent deformations such as rim defects, warping and the like, as well as cracking, on the cut site from bad cuts. Also, such a honeycomb molded body will tend to have great handle-ability for use in the following process.

Next, cell plugging will be performed as needed. In the cell plugging, the end portions of the exit sides of the entry side cell group, as well as the end portions of the entry sides of the exit side cell group, are plugged with a prescribed amount of plugging paste, which becomes the actual plug. When performing cell plugging, a hole plugging mask is first superimposed over the end faces (the cut faces after the cutting process) of the honeycomb molded body, after which the plugging paste is administered selectively only to the necessary cells.

Because both of the ends of the honeycomb molded body, which has underwent the above mentioned cutting process, are cut to be perpendicular with respect to the longitudinal direction, and, because substantial variance among the cut lengths of the honeycomb molded bodies tends not to occur, it may become easier to efficiently carry out the plugging process, in which the hole plugging mask is superimposed over both of the end faces of the honeycomb molded body and cells are plugged therethrough.

Although the above mentioned plugging paste is not limited in particular, it is preferable that the plugging paste, manufactured in the subsequent process, have a porosity of at least about 30 percent and at most about 75 percent. For example, it is possible to use, as the plugging paste, any one of the above mentioned wet mixtures.

Next, according to executing degreasing (at at least about 200 Degrees Celsius and at most about 500 Degrees Celsius, for example) and firing (at at least about 1400 Degrees Celsius and at most about 2300 Degrees Celsius, for example) under prescribed conditions to a ceramic dry body plugged with the above mentioned plugging paste, it is possible to manufacture a honeycomb fired body in which one of the end portions of the above mentioned cells are plugged, the same honeycomb fired body comprised of a multitude of cells established in rows along the longitudinal direction and cell walls which partition the cells individually, the same honeycomb fired body being constituted as a single unit.

The above mentioned conditions under which degreasing and firing are executed to the above mentioned ceramic dry body can be the same conditions that have been used conventionally when manufacturing a filter comprised of porous ceramic.

Next, a sealing material paste layer is formed by coating the side surfaces of the honeycomb fired body with a sealing material paste, which becomes the sealing material layer 11 (the adhesive layer). After this, another honeycomb fired body is stacked thereto the above mentioned honeycomb fired body, which has been coated with the sealing material paste layer. By carrying out the above process repeatedly, a honeycomb fired body aggregate of prescribed size is produced.

It is possible to use a substance containing inorganic fiber and/or inorganic particulate in addition to inorganic binder, organic binder, for example, as the above mentioned sealing material paste.

It is acceptable to use silica sol, alumina sol, and the like as the above mentioned inorganic binder. Also, it is acceptable to use the above singly, or use a combination of two or more of them in parallel. Of the above mentioned inorganic binders, silica sol is most preferable for use.

It is acceptable to use polyvinyl alcohol, methylcellulose, ethylcellulose, carboxy methylcellulose, and the like, for example, as the above mentioned organic binder. Also, it is acceptable to use the above singly, or use a combination of two or more of them in parallel. Of the above mentioned organic binders, carboxy methylcellulose is most preferable for use.

It is acceptable to use ceramic fibers such as silica-alumina, mullite, alumina, silica and the like, for example, as the above mentioned inorganic fiber. Also, it is acceptable to use the above singly, or use a combination of two or more of them in parallel. Of the above mentioned inorganic fiber, alumina fiber is most preferable for use.

It is acceptable to use carbide, nitride, and the like, for example, as the above mentioned inorganic particulate. More specifically, it is acceptable to use inorganic powder and the like comprised of silicon carbide, silicon nitride, boron nitride, or the like, for example, as the above mentioned inorganic particulate. It is acceptable to use the above singly, or use a combination of two or more of them in parallel. Of the above mentioned inorganic particulate, silicon carbide, which excels in its thermal conductivity properties, is most preferable for use.

And furthermore, it is also acceptable, according to need, to add a pore-forming agent such as balloon which is a micro sized hollow sphere, spherical acrylic particulate, or graphite and the like, having oxidant family ceramic as a component therein, to the above mentioned sealing material paste.

The above mentioned balloon is not particularly limited, as alumina balloons, glass micro balloon, shirasu balloon, fly ash balloon (FA balloon), mullite balloon, for example, are all acceptable for use. Of the above mentioned, alumina balloon is the most preferable for use.

Next, the honeycomb fired body aggregate is heated to dry the sealing material paste layer, which then hardens to become the sealing material layer (the adhesive layer).

Next, using a cutting apparatus such as a diamond cutter, a cutting process is administered to the honeycomb fired body aggregate, which is comprised of a plurality of honeycomb fired bodies adhered together by the sealing material layer (the adhesive layer), thereby producing a cylindrical ceramic block.

Afterward, another sealing material layer (a coat layer) is formed by coating the above mentioned sealing material paste to the outer periphery of the ceramic block. Thereby producing a honeycomb structure having the sealing material layer (the coat layer) disposed thereon the outer peripheral portion of a cylindrical ceramic block comprised of a plurality of honeycomb fired bodies adhered together by the sealing material layer (the adhesive layer).

Afterward, a catalyst is supported on the honeycomb structure as needed. It is also acceptable to support the above mentioned catalyst onto the honeycomb fired bodies, before the honeycomb fired bodies are manufactured into the honeycomb fired body aggregate.

In a case wherein the catalyst is supported, it is preferable that a film of alumina, which has a high specific surface area, be formed onto the surface of the honeycomb structure, and a co-catalyst or a catalyst such as platinum and the like is administered to the surface of the alumina film.

It is acceptable to apply a method of impregnating the honeycomb structure with a metallic compound containing an aluminum species such as Al(NO₃)₃ and the like, for example, and then heating, or a method of impregnating the honeycomb structure with a solution containing alumina powder and then heating and other methods, as a method of forming the alumina film onto the surface of the above mentioned honeycomb structure.

It is acceptable to apply a method of impregnating the honeycomb structure with a metallic compound containing a rare earth element such as Ce(NO₃)₃ and the like, for example, and then heating, as a method of administering the co-catalyst onto the above mentioned alumina film.

It is acceptable to apply a method of impregnating the honeycomb structure with a substance such as a dinitrodiammine platinum nitric acid solution ([Pt (NH₃)₂ (NO₂)₂] HNO₃, platinum content: about 4.5 percent by weight) and the like, for example, and then heating and other methods, as a method of administering the catalyst onto the above mentioned alumina film.

Also, it is acceptable to administer the catalyst with a method of first administering the catalyst to alumina particles in advance, and subsequently impregnating the honeycomb structure with the solution containing the alumina powder, which has been administered to the catalyst in advance.

In the honeycomb structure manufacturing method according to the embodiments put forth up to this point, although the honeycomb structure has been a honeycomb structure (termed “aggregate type honeycomb structure” hereinafter) having a configuration of a plurality of honeycomb fired bodies bound together by the sealing material layer (the adhesive layer), the honeycomb structure manufactured according to the honeycomb structure manufacturing method according to the embodiments of the present invention can also be a honeycomb structure (termed “single type honeycomb structure” hereinafter) having a configuration of a honeycomb fired body configured of a single cylindrical ceramic block. It is preferable that the main component material of the single type honeycomb structure be cordierite or aluminum titanite.

In a case of manufacturing a single type honeycomb structure of this sort, the only aspect that is different than in a case of manufacturing the aggregate type honeycomb structure is that the size of the honeycomb molded body, that is extrusion molded, is larger in the case of manufacturing a single type honeycomb structure than that in the case of manufacturing an aggregate type honeycomb structure, all other aspects used to manufacture a single type honeycomb structure are identical to those used in manufacturing an aggregate type honeycomb structure.

Next, in the same manner as in the aggregate type honeycomb structure manufacturing method, using a drying apparatus such as a microwave drying machine, a hot air drying machine, a dielectric drying machine, a reduced pressure drying machine, a vacuum drying machine, or a freeze drying machine and the like, the above mentioned honeycomb molded body is dried out. Next, the cutting process is executed, cutting both of the end portions of the dried honeycomb molded body.

Here, the method of cutting both end portions of the honeycomb molded body is identical to that used in the method of manufacturing the above-mentioned aggregate type honeycomb structure, and so description thereof will be omitted at this time.

Next, cell plugging is executed, and the end portions of the exit sides of the entry side cell group, as well as the end portions of the entry sides of the exit side cell group, are plugged with a prescribed amount of plugging paste.

Afterward, in the same manner as in the manufacture of the aggregate type honeycomb structure, degreasing and firing are executed, thereby producing a ceramic block. And as needed, a sealing material layer (the coat layer) is formed, thereby finishing production of the single type honeycomb structure. It is also acceptable to support a catalyst on the above mentioned single type honeycomb structure as well, as is the method put forth herein above.

Also, although description has been centered mainly around the honeycomb filter, for the purpose of capturing particulates airborne within exhaust gas, as the honeycomb structure, the above mentioned honeycomb structure can also be used suitably as a catalyst supporter (honeycomb catalyst) for converting exhaust gas.

With the honeycomb structure manufacturing method according to the embodiments of the present invention described herein above, it may become easier to manufacture a honeycomb structure with high operational efficiency.

Also, in a case of manufacturing a honeycomb structure according to the above mentioned method, the end faces of the honeycomb molded body are cut in such a manner as to be perpendicular with respect to the longitudinal direction, and, exhibit consistent length between cuts. Because of this, it is possible to attain a honeycomb structure having consistent appearance, form, and functionality, as the finished product. Also, because it may become easier to effectively and easily improve the efficiency of cutting treatment, it may become easier to improve the efficiency of the entire manufacturing process for the manufacture of a honeycomb structure.

### EXAMPLES

Herein below, in the cutting process used for cutting both end portions of the honeycomb molded body, the case of executing cutting to both end portions using the cutting apparatus of the present invention, providing two cutting disks, and the case of first executing cutting to one end portion, and subsequently executing cutting to the other end portion at a different timing, will each be measured, and the cutting method of the honeycomb molded body of each case will be evaluated as to the influence it has on the full lengths of the honeycomb fired body. Note that the honeycomb fired body was obtained through firing of the honeycomb molded body having both end portions cut using the cutting apparatus of the present invention. Also, the full length of the honeycomb fired body in the case of administering the drying treatment before executing cutting to both end portions of the honeycomb molded body, and the full length of the honeycomb fired body in the case of administering the drying treatment after executing cutting to both end portions, will be compared, and the influence the drying treatment has on the cut length of the honeycomb molded body in each case will be evaluated. Also, it will be evaluated as to how the state of the end faces of the produced honeycomb fired body differs in the case of executing cutting while holding both sides of the cut site of the honeycomb molded body, and in the case of executing cutting while holding only one side of the cut site of the honeycomb molded body.

The reason each evaluation method had been employed here was that as the full length of the honeycomb fired body was equal to that of the full length of the honeycomb structure, at the same time if deviation occurs on the full length of the honeycomb fired body arising from deviation in the cut length of the honeycomb molded body, it is thought that this will influence the uniformity of the form and physical properties of the end faces of the honeycomb structure.

Also, the term ‘full length’ of the honeycomb fired body is used to refer to the distance in between the end faces (cut faces) along the direction that the cell passages penetrate.

### Example 1

First, 250 kg of silicon carbide powder having a mean particle diameter of 10 μm, 100 kg of α-type silicon carbide powder having a mean particle diameter of 0.5 μm, and 20 kg of organic binder (methylcellulose) were blended together to prepare a powder mixture.

Next, 12 kg of lubricating agent (UNILUBE, Manufactured by NOF Corp.), 5 kg of plasticizer (glycerin), and 65 kg of water were blended in a separate container to prepare a liquid mixture. Next, using a wet mixer machine, the powder mixture and the liquid mixture were blended together, thereby preparing the wet mixture.

And the moisture content of the above prepared wet mixture was 14 percent by weight.

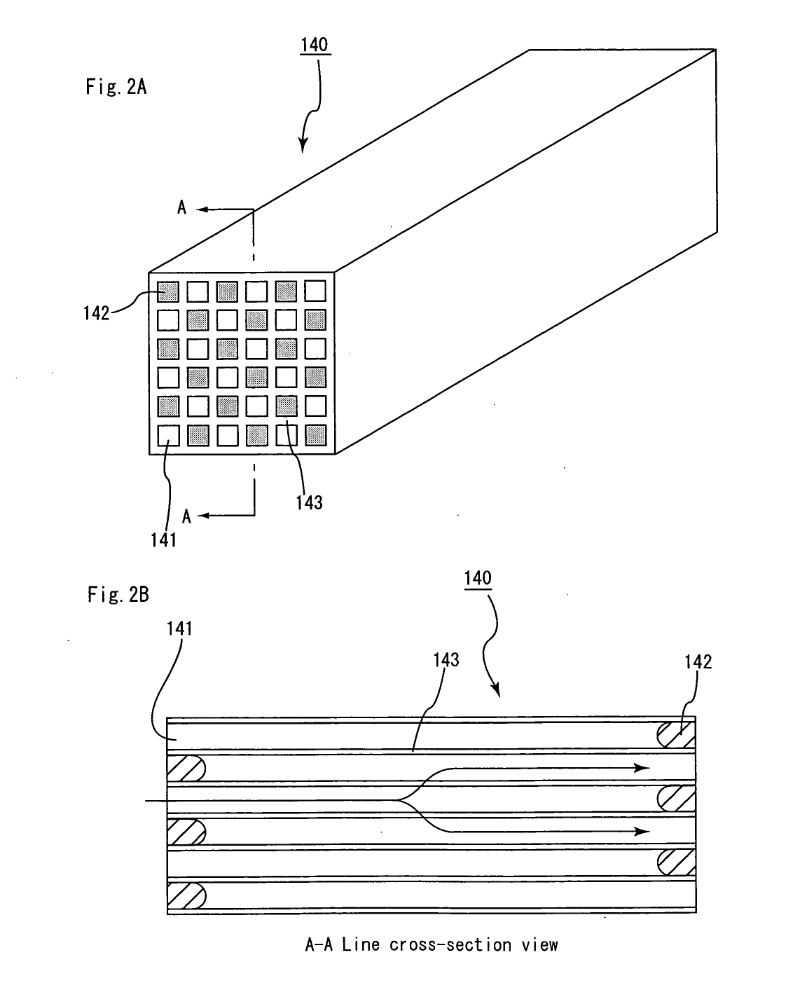

Next, using a conveyer machine, the wet mixture was conveyed to the extrusion molding machine, and was then extrusion-molded to produce a molded body having the form shown in FIG. 2.

Using a microwave dryer or the like, a drying treatment was then administered to the above raw molded body, which thereby produced the dried honeycomb molded body. The moisture content of the honeycomb molded body after drying was 1 percent by weight.

Next, using the two cutting disks of the cutting apparatus of the present invention, which is shown in FIG. 3, both end portions of the dried honeycomb molded body were cut by the two cutting disks while the dried honeycomb molded body was clamped in place by the molded body clamping member and in a state of being moved by the rotation of the rotary body. The molded body clamping member in this case used the mode of molded body clamping member shown in FIG. 4A. And the cutting disks were diamond cutters (Manufactured by Disco Abrasive Systems K.K.) having a diameter of 205 mm and a thickness of 1.2 mm. The rotational velocity occurring on the rim of the rotary body was 2 m/min, and the peripheral velocity of the cutting disk was 4300 m/min.

Also, the length of the dried honeycomb molded body was cut to its length taking into consideration shrinkage, so that its length after the above mentioned firing treatment has been administered will become 150.5 mm.

Plugging paste of a composition identical to that of the above mentioned wet mixture was then administered to prescribed cells of the honeycomb molded body having both ends cut.

Next, after administering another drying treatment using a drying machine, degreasing was executed at 400 Degrees Celsius, and firing was executed for three hours at atmospheric pressure in an argon atmosphere at 2200 Degrees Celsius, thereby producing a honeycomb fired body made from a silicon carbide fired body having a porosity of 40 percent, a mean pore diameter of 12.5 μm, a size of 34.3 mm×34.3 mm×150.5 mm, with the number of cells (cell concentration) of 46.5 pcs/cm², and a cell wall thickness of 0.20 mm.

### Example 2

In this embodiment, the only aspect different from Example 1 was that the molded body clamping member uses the mode of molded body clamping member shown in FIG. 4C as the molded body clamping member of the present invention.

### Comparative Example 1

When executing cutting of both end portions of the dried honeycomb molded body, the side faces of the honeycomb molded body were held in place, and first, one end portion was cut off, using a cutting blade, slicing into the honeycomb molded body from the top and proceeding in the direction of the bottom until the end portion was cut off. Next, after the honeycomb molded body was reversed, the other end portion was cut off in the same manner as above, thereby producing a honeycomb molded body of prescribed length. Besides this manner of cutting, all other aspects in producing the honeycomb fired body were identical to those of Example 1.

### Comparative Example 2

In this example of producing a honeycomb fired body, the only aspect different from Comparative Example 1 was that cutting was executed on both end portions of the honeycomb molded body in a state before drying of the raw molded body.

### Reference Example 1

In this example of producing a honeycomb fired body, the hot air drying treatment was not administered before both end portions of the honeycomb molded body were cut, and the microwave drying treatment was administered after cutting. All other methods used to produce a honeycomb fired body were identical to those of Example 1.

### (Measurement of the Full Length of the Honeycomb Fired Body)

The full lengths of the honeycomb fired bodies produced in Examples 1 and 2, the Comparative Examples 1 and 2, and Reference example 1, 10 samples from each method, were measured using a digital caliper (manufactured by Mitutoyo Corp.) in evaluating the influence that the timing of cutting processing executed to both end portions of the honeycomb molded body, and the order of drying treatment had on the full length of the honeycomb fired body. The results are shown in Table 1.

### (Observation of the State of the End Face)

Using the naked eye, the state of the end faces of the honeycomb fired body produced in Examples 1 and 2, the Comparative Examples 1 and 2, and Reference Example 1, were observed, and the instances of samples in which chipping (cell defect) and crushed cells (cell wall deformation) were counted. The results are shown in Table 1.

TABLE 1

| | | | | | | | | | | | mean | | number | |
|---|---|---|---|---|---|---|---|---|---|---|---|---|---|---|
| | full length of honeycomb fired body (mm) | | | | | | | | | | value | standard | of | crushed |
| | 1 | 2 | 3 | 4 | 5 | 6 | 7 | 8 | 9 | 10 | (mm) | deviation | chipping | cells |
| Example 1 | 150.51 | 150.52 | 150.52 | 150.52 | 150.50 | 150.51 | 150.51 | 150.52 | 150.51 | 150.52 | 150.51 | 0.007 | 1/10 | 0/10 |
| Example 2 | 150.51 | 150.50 | 150.51 | 150.53 | 150.51 | 150.52 | 150.52 | 150.51 | 150.51 | 150.52 | 150.51 | 0.008 | 0/10 | 0/10 |
| Com- | 150.64 | 150.52 | 150.49 | 150.58 | 150.61 | 150.85 | 150.77 | 151.01 | 151.13 | 150.81 | 150.74 | 0.212 | 3/10 | 0/10 |
| parative | | | | | | | | | | | | | | |
| Example 1 | | | | | | | | | | | | | | |
| Com- | 150.75 | 150.48 | 150.52 | 150.61 | 150.98 | 150.33 | 150.17 | 151.20 | 150.11 | 151.33 | 150.65 | 0.416 | 0/10 | 10/10 |
| parative | | | | | | | | | | | | | | |
| Example 2 | | | | | | | | | | | | | | |
| Reference | 150.52 | 150.38 | 150.45 | 150.49 | 150.10 | 150.54 | 150.52 | 150.45 | 150.52 | 150.52 | 150.45 | 0.132 | 2/10 | 0/10 |
| Example 1 | | | | | | | | | | | | | | |

As can be clearly seen in Table 1, with the honeycomb fired body produced in Example 1, the mean value of full length was 150.51 mm, and the standard deviation was 0.007. With the honeycomb fired body produced in Example 2, the mean value of full length was 150.51 mm, and the standard deviation was 0.008. As can be seen, there was very little deviation in Examples 1 and 2. And in the Reference Example 1, the mean value of full length of the honeycomb fired body produced was 150.45 mm, and the standard deviation was 0.132. As can be seen here, although the length of all the honeycomb fired bodies produced in the Reference Example 1 lies within the acceptable range for use, the deviation was nonetheless relatively large, compared to that of Examples 1 and 2.

On the other hand, in the Comparative Example 1, the mean value of full length of the honeycomb fired body produced was 150.74 mm, and the standard deviation was 0.212. As can be seen here, the deviation was large, and the Comparative Example 1 produced honeycomb fired bodies outside the acceptable range for use, and the cut lengths of the honeycomb molded bodies were inconsistent. In the Comparative Example 2, the mean value of full length of the honeycomb fired body produced was 150.65 mm, and the standard deviation was 0.416. As can be seen here, the deviation was large compared to even the Comparative Example 1, and thus the Comparative Example 2 also produced honeycomb fired bodies outside the acceptable range for use.

In the Reference Example 1, the cause behind such a large deviation when compared to Examples 1 and 2 is thought to be that because the drying process was administered to the honeycomb molded body after both of the end portions had been cut, shrinkage of the cut length of the honeycomb molded body occurred due to the drying treatment, thus generating the deviation on the full length of the honeycomb fired body. Therefore, it is preferable that the drying treatment be administered to the honeycomb molded body before both ends of the honeycomb molded body were cut.

On the other hand, the cause behind the deviation in the full length of the honeycomb fired body in the Comparative Example 1 is thought to be that, when cutting both end portions of the honeycomb molded body, because it is necessary to first execute the complicated process of performing position alignment, position securing, and then cutting for one end portion, and subsequently executing the same complicated process to the other end portion, there occur many errors in the cut length of the honeycomb molded body, which as a result gives a large deviation in the full length of the honeycomb fired body. Furthermore, the cause behind the deviation in the full length of the honeycomb fired body in the Comparative Example 2 is thought to be that in addition to the complicated process observed in the Comparative Example 1, the drying treatment was administered to the honeycomb molded body after cutting, and the fact that the cut length of the honeycomb molded body underwent shrinkage by the drying treatment made influence on the deviation.

After conducting observation as to whether or not chipping (cell defect) or crushed cells have occurred on the end faces, it was concluded that in the honeycomb fired bodies produced in Examples 1 and 2, there were almost no (1 instance of chipping out of 10 samples in Example 1, and no instances of chipping in the 10 samples of Example 2) instances of chipping, and absolutely no instances of crushed cells as well.

And in Example 1, the reason that a slight amount of chipping has been observed is thought to be that because the molded body clamping member holds only one side of the cut site when executing cutting of the end portions, a free end exists, and as a result of deviation or slipping occurring at the free end as the cut progresses, chipping can be observed when the cut was completed.

On the other hand, in Example 2, the reason that there were no occurrences of chipping observed is thought to be that because both sides of the cut site were held when executing cutting of the end portions, which means that there was no free end.

Furthermore, the chipping that was observed in Example 1 was small compared to the chipping observed in the Comparative Example 1. And although there would be no problem in using the honeycomb fired body produced in Example 1 as a finished product, it is thought to be preferable to perform cutting of both of the end portions of the honeycomb molded body only after both sides of the cut site have been held in place, in order to prevent slight instances of defect of the cell wall as mentioned above.

On the other hand, with the honeycomb fired body produced in the Comparative Example 1, there were no instances of crushed cells, and the honeycomb fired bodies for the most part had the desired form, however, out of the 10 samples, the honeycomb fired bodies of 3 of them exhibited end faces with great cracking. This is thought to be caused by stress focused on specific portions of the cut site caused by the cutting blade cutting into the honeycomb molded body from the top and proceeding in the direction of the bottom, and also is thought to be caused during handling of the honeycomb molded body because, after one end portion was cut, the honeycomb molded body was reversed so as to cut the other end portion. Therefore, it can be said that as in the cutting apparatus of the present invention, the point of executing cutting according to a cutting disk, which constantly changes its direction of contact with the cut site with time, thus diffusing stress, is very effective in preventing occurrences of the above mentioned type of defect and chipping.

Also, it can be said that it is preferable to execute cutting of both ends of the honeycomb molded body simultaneously using two cutting disks.

In the honeycomb fired body produced in the Comparative Example 2, while there were no instances of chipping on the end faces, crushed cells were observed on all 10 samples evaluated therein. This is thought to be that because when performing cutting of the end portions of the honeycomb molded body in the Comparative Example 2, the cutting blade cuts into the honeycomb molded body, which has yet to be administered the drying treatment and thus is relatively weak in strength, from the top and proceeding in the direction of the bottom, during which, the stress of the cutting has the chance to focus on a specific portion to a degree at which the cell walls of those portions could not withstand.

And in the honeycomb fired body produced in the Reference Example 1, although there was no instances of crushed cells, there were confirmed instances of slight cracking of the cell walls of the honeycomb fired bodies of 2 samples in the lot of 10. This is thought to be that because if cutting of both ends of the honeycomb molded body was executed after the drying treatment has been administered, the hardness of the cell walls would have increased, therefore, although the state of the end face was acceptable regardless of the cutting method, if cutting is executed to both ends of the honeycomb molded body before the drying treatment has been administered, the moisture content is still high and the strength is low, which makes it more easy for chipping (cell defect) to occur. Therefore, as has been considered in the evaluation of the full length of the above mentioned honeycomb fired body, it is thought that it is most preferable to administer the drying process before cutting is executed to both end portions of the honeycomb molded body.

What is claimed as new and desired to be secured by Letters Patent of the United States is:

1. A cutting apparatus configured to cut an end portion of a pillar-shaped honeycomb molded body having a multiplicity of cells that are established in rows in the longitudinal direction and partitioned by cell walls, said cutting apparatus comprising:
a rotary body having a rotary shaft established horizontally;
a molded body clamping member configured to clamp a honeycomb molded body established on the rim of said rotary body; and
at least one cutting disk,
wherein
said cutting apparatus is configured in such a manner as to execute cutting of an end portion of said honeycomb molded body while said honeycomb molded body, which is clamped by said molded body clamping member, is in a state of being put in motion according to the rotary movement of said rotary body.

2. The cutting apparatus according to claim 1,
wherein
said rotary body has a disc form.

3. The cutting apparatus according to claim 1,
wherein
said molded body clamping member is provided with a pair of opposing holding members, and is configured to hold said honeycomb molded body in a manner exposing both end portions of said honeycomb molded body when clamping said honeycomb molded body.

4. The cutting apparatus according to claim 1,
wherein
said molded body clamping member is provided with two pairs of separated opposing holding members, and is configured to hold said honeycomb molded body in a manner exposing both end portions of said honeycomb molded body when clamping said honeycomb molded body.

5. The cutting apparatus according to claim 4,
wherein
the contact width of a single holding member of said molded body clamping member with respect to said honeycomb molded body is about 10 mm or more.

6. The cutting apparatus according to claim 1,
wherein
said molded body clamping member is configured to hold both sides of a cut site of said honeycomb molded body simultaneously when clamping said honeycomb molded body.

7. The cutting apparatus according to claim 6,
wherein
said molded body clamping member is provided with two pairs of holding members configured to interpose said cut site therebetween, and is configured to hold both sides of one cut site of said honeycomb molded body simultaneously.

8. The cutting apparatus according to claim 6,
wherein
said molded body clamping member is provided with a holding member in a form starting out as a single body extending from the joint site with said rotary body and forking into two separate ends, and is configured to hold both sides of one cut site of said honeycomb molded body simultaneously.

9. The cutting apparatus according to claim 1,
wherein
the minimum distance between the contact portion or the contact face shared by said honeycomb molded body clamped to said molded body clamping member and said molded body clamping member, and the cut site of said honeycomb molded body is at least about 0.5 mm and at most about 1 mm.

10. The cutting apparatus according to claim 1,
wherein
said molded body clamping member is configured to clamp said honeycomb molded body in parallel with said rotary shaft of said rotary body.

11. The cutting apparatus according to claim 10,
wherein
said molded body clamping member is provided with a parallel adjustment member, and is configured in such a manner that a contact face of said parallel adjustment member with said honeycomb molded body is disposed in parallel with said rotary shaft of said rotary body.

12. The cutting apparatus according to claim 10,
wherein
said molded body clamping member has a step portion formed thereon, and is configured in such a manner that, when said honeycomb molded body is clamped to said step portion to fit exactly, the clamped honeycomb molded body is in parallel with said rotary shaft.

13. The cutting apparatus according to claim 1,
further configured in such a manner as to provide two of said cutting disks, thus enabling cutting of both end portions of said honeycomb molded body simultaneously.

14. The cutting apparatus according to claim 1,
wherein
said cutting disk is in a form in which the thickness of a rim-zone portion gradually becomes smaller towards the outer rim.

15. The cutting apparatus according to claim 1,
wherein
said cutting disk is in a form in which the thickness of a center portion and that of a rim-zone portion are relatively large, while the thickness of a portion between the center portion and the rim-zone portion is small compared to that of the center portion and that of the rim-zone portion.

16. The cutting apparatus according to claim 1,
wherein
said cutting disk is in a form in which only the rim-zone portion is thick.

17. The cutting apparatus according to claim 1,
wherein
said cutting disk has a thickness of at least about 0.4 mm and at most about 2 mm.

18. The cutting apparatus according to claim 1,
wherein
said cutting disk has a diameter of at least about 100 mm and at most about 300 mm.

19. The cutting apparatus according to claim 1,
wherein
said cutting disk comprises steel blades constituted by steel, sintered-type diamond blades using metallic powder bond, sintered-type diamond blades using thermosetting resin, blades formed from steel core and diamond metal bonded and united as one, or blades from industrial diamond clamped with electrocast bond.

20. The cutting apparatus according to claim 1,
wherein
abrasive grains made of diamond powder, alumina powder, silicon carbide powder, or silicon nitride powder are placed onto said cutting disk.

21. A honeycomb molded body cutting method configured to enable cutting of a pillar-shaped honeycomb molded body having a multiplicity of cells that are established in rows in the longitudinal direction and partitioned by cell walls according to using a cutting apparatus, said cutting apparatus comprising:
a rotary body having a rotary shaft established horizontally;
a molded body clamping member configured to clamp a honeycomb molded body established on the rim of said rotary body; and
at least one cutting disk,
wherein
said honeycomb molded body cutting method is configured to perform cutting of the end portion of said honeycomb molded body according to said cutting disk, while moving said honeycomb molded body according to the rotary movement of said rotary body, after said honeycomb molded body is clamped in place by said molded body clamping member of said rotary body.

22. The honeycomb molded body cutting method according to claim 21,
wherein
said rotary body has a disc form.

23. The honeycomb molded body cutting method according to claim 21,
wherein
said molded body clamping member is provided with a pair of opposing holding members, and is configured to hold said honeycomb molded body in a manner exposing both end portions of said honeycomb molded body when clamping said honeycomb molded body.

24. The honeycomb molded body cutting method according to claim 21,
wherein
said molded body clamping member is provided with two pairs of separated opposing holding members, and is configured to hold said honeycomb molded body in a manner exposing both end portions of said honeycomb molded body when clamping said honeycomb molded body.

25. The honeycomb molded body cutting method according to claim 24,
wherein
the contact width of a single holding member of said molded body clamping member with respect to said honeycomb molded body is about 10 mm or more.

26. The honeycomb molded body cutting method according to claim 21,
wherein
said molded body clamping member is configured to hold both sides of a cut site of said honeycomb molded body simultaneously when clamping said honeycomb molded body.

27. The honeycomb molded body cutting method according to claim 26,
wherein
said molded body clamping member is provided with two pairs of holding members configured to interpose said cut site therebetween, and is configured to hold both sides of one cut site of said honeycomb molded body simultaneously.

28. The honeycomb molded body cutting method according to claim 26,
wherein
said molded body clamping member is provided with a holding member in a form starting out as a single body extending from the joint site with said rotary body and forking into two separate ends, and is configured to hold both sides of one cut site of said honeycomb molded body simultaneously.

29. The honeycomb molded body cutting method according to claim 21,
wherein
the minimum distance between the contact portion or the contact face shared by said honeycomb molded body clamped to said molded body clamping member and said molded body clamping member, and the cut site of said honeycomb molded body is at least about 0.5 mm and at most about 1 mm.

30. The honeycomb molded body cutting method according to claim 21,
wherein
said molded body clamping member is configured to clamp said honeycomb molded body in parallel with said rotary shaft of said rotary body.

31. The honeycomb molded body cutting method according to claim 30,
wherein
said molded body clamping member is provided with a parallel adjustment member, and is configured in such a manner that a contact face of said parallel adjustment member with said honeycomb molded body is disposed in parallel with said rotary shaft of said rotary body.

32. The honeycomb molded body cutting method according to claim 30,
wherein
said molded body clamping member has a step portion formed thereon, and is configured in such a manner that, when said honeycomb molded body is clamped to said step portion to fit exactly, the clamped honeycomb molded body is in parallel with said rotary shaft.

33. The honeycomb molded body cutting method according to claim 21,
wherein
said cutting apparatus is provided with two of said cutting disks, thus enabling cutting of both end portions of said honeycomb molded body simultaneously.

34. The honeycomb molded body cutting method according to claim 21,
wherein
said cutting disk is in a form in which the thickness of a rim-zone portion gradually becomes smaller towards the outer rim.

35. The honeycomb molded body cutting method according to claim 21,
wherein
said cutting disk is in a form in which the thickness of a center portion and that of a rim-zone portion are relatively large, while the thickness of a portion between the center portion and the rim-zone portion is small compared to that of the center portion and that of the rim-zone portion.

36. The honeycomb molded body cutting method according to claim 21,
wherein
said cutting disk is in a form in which only the rim-zone portion is thick.

37. The honeycomb molded body cutting method according to claim 21,
wherein
said cutting disk has a thickness of at least about 0.4 mm and at most about 2 mm.

38. The honeycomb molded body cutting method according to claim 21,
wherein
said cutting disk has a diameter of at least about 100 mm and at most about 300 mm.

39. The honeycomb molded body cutting method according to claim 21,
wherein
said cutting disk comprises steel blades constituted by steel, sintered-type diamond blades using metallic powder bond, sintered-type diamond blades using thermosetting resin, blades formed from steel core and diamond metal bonded and united as one, or blades from industrial diamond clamped with electrocast bond.

40. The honeycomb molded body cutting method according to claim 21,
wherein
abrasive grains made of diamond powder, alumina powder, silicon carbide powder, or silicon nitride powder are placed onto said cutting disk.

41. A honeycomb structure manufacturing method configured to manufacture a honeycomb structure made from a honeycomb fired body attained by molding ceramic raw material to form a pillar-shaped honeycomb molded having a multiplicity of cells established in rows in the longitudinal direction and partitioned by cell walls, and subsequently using a cutting apparatus to execute a cutting process to cut both ends of the honeycomb molded body, and firing said honeycomb molded body thereafter, said cutting apparatus comprising:
a rotary body having a rotary shaft established horizontally;
a molded body clamping member configured to clamp a honeycomb molded body established on the rim of said rotary body; and
at least one cutting disk,
wherein
said honeycomb structure manufacturing method is configured to, according to said cutting process, perform cutting of an end portion of said honeycomb molded body according to said cutting disk, while moving said honeycomb molded body according to the rotary movement of said rotary body, after said honeycomb molded body is clamped in place by said molded body clamping member.

42. The honeycomb structure manufacturing method according to claim 41,
wherein
said rotary body has a disc form.

43. The honeycomb structure manufacturing method according to claim 41,
wherein
said molded body clamping member is provided with a pair of opposing holding members, and is configured to hold said honeycomb molded body in a manner exposing both end portions of said honeycomb molded body when clamping said honeycomb molded body.

44. The honeycomb structure manufacturing method according to claim 41,
wherein
said molded body clamping member is provided with two pairs of separated opposing holding members, and is configured to hold said honeycomb molded body in a manner exposing both end portions of said honeycomb molded body when clamping said honeycomb molded body.

45. The honeycomb structure manufacturing method according to claim 44,
wherein
the contact width of a single holding member of said molded body clamping member with respect to said honeycomb molded body is about 10 mm or more.

46. The honeycomb structure manufacturing method according to claim 41,
wherein
said molded body clamping member is configured to hold both sides of a cut site of said honeycomb molded body simultaneously when clamping said honeycomb molded body.

47. The honeycomb structure manufacturing method according to claim 46,
wherein
said molded body clamping member is provided with two pairs of holding members configured to interpose said cut site therebetween, and is configured to hold both sides of one cut site of said honeycomb molded body simultaneously.

48. The honeycomb structure manufacturing method according to claim 46,
wherein
said molded body clamping member is provided with a holding member in a form starting out as a single body extending from the joint site with said rotary body and forking into two separate ends, and is configured to hold both sides of one cut site of said honeycomb molded body simultaneously.

49. The honeycomb structure manufacturing method according to claim 41,
wherein
the minimum distance between the contact portion or the contact face shared by said honeycomb molded body clamped to said molded body clamping member and said molded body clamping member, and the cut site of said honeycomb molded body is at least about 0.5 mm and at most about 1 mm.

50. The honeycomb structure manufacturing method according to claim 41,
wherein
said molded body clamping member is configured to clamp said honeycomb molded body in parallel with said rotary shaft of said rotary body.

51. The honeycomb structure manufacturing method according to claim 50,
wherein
said molded body clamping member is provided with a parallel adjustment member, and is configured in such a manner that a contact face of said parallel adjustment member with said honeycomb molded body is disposed in parallel with said rotary shaft of said rotary body.

52. The honeycomb structure manufacturing method according to claim 50,
wherein
said molded body clamping member has a step portion formed thereon, and is configured in such a manner that, when said honeycomb molded body is clamped to said step portion to fit exactly, the clamped honeycomb molded body is in parallel with said rotary shaft.

53. The honeycomb structure manufacturing method according to claim 41,
wherein
said cutting apparatus is provided with two of said cutting disks, thus enabling cutting of both end portions of said honeycomb molded body simultaneously.

54. The honeycomb structure manufacturing method according to claim 41,
wherein
said cutting disk is in a form in which the thickness of a rim-zone portion gradually becomes smaller towards the outer rim.

55. The honeycomb structure manufacturing method according to claim 41,
wherein
said cutting disk is in a form in which the thickness of a center portion and that of a rim-zone portion are relatively large, while the thickness of a portion between the center portion and the rim-zone portion is small compared to that of the center portion and that of the rim-zone portion.

56. The honeycomb structure manufacturing method according to claim 41,
wherein
said cutting disk is in a form in which only the rim-zone portion is thick.

57. The honeycomb structure manufacturing method according to claim 41,
wherein
said cutting disk has a thickness of at least about 0.4 mm and at most about 2 mm.

58. The honeycomb structure manufacturing method according to claim 41,
wherein
said cutting disk has a diameter of at least about 100 mm and at most about 300 mm.

59. The honeycomb structure manufacturing method according to claim 41,
wherein
said cutting disk comprises steel blades constituted by steel, sintered-type diamond blades using metallic powder bond, sintered-type diamond blades using thermosetting resin, blades formed from steel core and diamond metal bonded and united as one, or blades from industrial diamond clamped with electrocast bond.

60. The honeycomb structure manufacturing method according to claim 41,
wherein
abrasive grains made of diamond powder, alumina powder, silicon carbide powder, or silicon nitride powder are placed onto said cutting disk.

61. The honeycomb structure manufacturing method according to claim 41,
wherein
a drying treatment is administered to said honeycomb molded body after said honeycomb molded body has been produced by molding ceramic raw materials, yet before both ends of said honeycomb molded body are cut.
